(19) United States
(12) Patent Application Publication
(10) Pub. No.: US 2018/0203297 A1
(43) Pub. Date: Jul. 19, 2018

(54) SURFACE LIGHT SOURCE DEVICE AND LIQUID CRYSTAL DISPLAY DEVICE

(71) Applicant: MITSUBISHI ELECTRIC CORPORATION, Tokyo (JP)

(72) Inventors: Tetsuo FUNAKURA, Tokyo (JP); Tomohiro SASAGAWA, Tokyo (JP); Eiji NIIKURA, Tokyo (JP); Nami OKIMOTO, Tokyo (JP); Saki MAEDA, Tokyo (JP)

(73) Assignee: MITSUBISHI ELECTRIC CORPORATION, Tokyo (JP)

(21) Appl. No.: 15/559,251

(22) PCT Filed: Mar. 16, 2016
(86) PCT No.: PCT/JP2016/058281

§ 371 Date: Sep. 18, 2017

(30) Foreign Application Priority Data
Mar. 19, 2015 (JP) 2015-056358
Apr. 24, 2015 (JP) 2015-089176

(51) Int. Cl. G02F 1/1335; G02B 27/09

(52) U.S. Cl. CPC G02F 1/133602; G02B 27/0977

(57) ABSTRACT

A surface light source device includes laser light sources, first light guide elements, and a second light guide element. The laser light sources emit laser beams. The first light guide elements mix a plurality of laser beams emitted from the laser light sources to convert the plurality of laser beams to linear light. The second light guide element receives the linear light and converts the linear light to planar light. The laser light sources are disposed in regions separated by the first light guide elements. The surface light source device dissipates heat released from the laser light sources to the regions.

### TECHNICAL FIELD

The present invention relates to a surface light source device that emits planar light. Moreover, the present invention relates to a liquid crystal display device including the surface light source device and a liquid crystal display element.

### BACKGROUND ART

A liquid crystal display element (also referred to as a liquid crystal panel) included in a liquid crystal display device does not produce light by itself. Thus, the liquid crystal display device includes, as a light source for illuminating the liquid crystal display element, a surface light source device on the back side of the liquid crystal display element. The liquid crystal display element receives light emitted from the surface light source device and outputs light including image information (image light).

In recent years, a liquid crystal display device having a wide range of color reproduction has been required, and a backlight device employing single-color LEDs having high color purity has been proposed. Colors of the single-color LEDs are, for example, three colors of red, green, and blue. A backlight device using lasers having higher color purity than that of the single-color LED has also been proposed. Colors of the lasers are, for example, red, green, and blue. The high color purity means a narrow wavelength range and high monochromaticity. Thus, the liquid crystal display device using the lasers can provide an image having a wide range of color reproduction. That is, the liquid crystal display device using the lasers can significantly improve image quality.

The laser, however, is a point light source having a very high directivity. The “point light source” is a light source that radiates light from a single point. Here, the “single point” means a point having such a small area that the light source can be regarded as a point in optical calculation, in consideration of performance of a product.

Thus, a surface light source device using a laser light source needs an optical system for converting point-shaped laser light beams to planar light. As this optical system, for example, a light guide plate having a flat plate shape is used. Laser light beams incident on an end portion of the light guide plate are mixed together while traveling inside the light guide plate to become linear light. This linear light is successively emitted to the outside of the light guide plate so that the planar light is formed.

In some light sources using the single-color LEDs or lasers of three primary colors, however, their photoconversion efficiency significantly decreases as the temperature of the element rises. The “photoconversion efficiency” is efficiency in converting electric power (electric energy) to an optical output. The “photoconversion efficiency” is also referred to as light emission efficiency. The “photoconversion efficiency” is also simply referred to as conversion efficiency. In particular, when a red laser continuously emits light with high power at high temperature, degradation is accelerated and the lifetime of the element is shortened. For this reason, to obtain a desired quantity of light at high ambient temperatures, a heat dissipation mechanism is needed in general.

A liquid crystal display device 1 described in Patent Literature 1 includes a rear frame 7 including standing portions 8 formed by bending longer-side edges. LED modules (light source modules) 9 which are formed in a thin rectangular shape and on which a plurality of LEDs 11 are mounted are disposed on the sides of surfaces of the two standing portions 8 which face each other (paragraph 0009). A heat sink 27, which is in thermal contact with the rear frame 7, is disposed on a rear of the liquid crystal display device 1 (paragraph 0012). The liquid crystal display device 1 can release heat generated by the LEDs 11 into the air (paragraph 0015).

### PRIOR ART LITERATURE

### Patent Literature

Patent Literature 1: Japanese Patent Application Publication No. 2006-267936 (paragraphs 0009, 0012, and 0015, FIGS. 1 and 2)

### SUMMARY OF THE INVENTION

### Problem To Be Solved By The Invention

In the liquid crystal display device 1 described in Patent Literature 1, however, the heat of the LEDs 11 is transferred to the rear frame 7 and dissipated from the heat sink 27. Thus, the heat of the LEDs 11 spreads through the entire rear frame 7, and therefore, the heat sink 27 needs to be disposed in a wide area of the rear frame 7.

An object of the present invention is to provide a surface light source device that is made in view of the above and dissipates heat with a limited region by reducing transfer of heat generated by a light source.

### Means Of Solving The Problem

The present invention is made in view of the above and a surface light source device includes laser light sources that emit a plurality of laser beams; first light guide elements that mix the plurality of laser beams emitted from the laser light sources to convert the plurality of laser beams to linear light; and a second light guide element that receives the linear light and converts the linear light to planar light. The laser light sources are disposed in regions separated by the first light guide elements so that heat released from the laser light sources to the regions is dissipated.

### Effects Of The Invention

According to the present invention, it is possible to reduce transfer of heat emitted from a light source and dissipate the heat in a limited region.

### BRIEF DESCRIPTION OF THE DRAWINGS

FIG. 1 is an exploded view illustrating a configuration of a liquid crystal display device 900 according to a first embodiment of the present invention.

FIG. 2 is a cross-sectional view illustrating an assembled state of a surface light source device 100 according to the first embodiment of the present invention.

FIG. 3 is a schematic view illustrating an arrangement of light guide plates 40 and 50 and laser light sources 21 and 22 of the surface light source device 100 according to the first embodiment of the present invention.

FIG. 4 is an explanatory diagram for describing behavior of light traveling in the upward light guide plate 40 of the surface light source device 100 according to the first embodiment of the present invention.

FIG. 5 is an explanatory diagram for describing behavior of light traveling in the downward light guide plate 50 of the surface light source device 100 according to the first embodiment of the present invention.

FIG. 6 is a perspective view illustrating a configuration of heat dissipators 11 and 12 of the surface light source device 100 according to the first embodiment of the present invention.

FIG. 7 is a schematic view illustrating an arrangement of the laser light sources 21 and 22 and laser beams 25 and 26 of the surface light source device 100 according to the first embodiment of the present invention.

FIG. 8 is an explanatory diagram for describing heat transfer of the laser light sources 21 and 22 of the surface light source device 100 according to the first embodiment of the present invention.

FIG. 9 is a view illustrating an arrangement of an upward light guide plate 40 and laser light sources 21_{R}, 21_{G}, and 21_{B} used in a surface light source device 110 according to a first modified example.

FIG. 10 is a view illustrating an arrangement of an upward light guide plate 40 and laser light sources 21_{R}, 21_{G}, and 21_{B} used in a surface light source device 120 according to a second modified example.

FIG. 11 is a view illustrating an arrangement of an upward light guide plate 40, laser light sources 21_{R}, 21_{G}, and 21_{B} and a heat dissipator 11 used in a surface light source device 130 according to a third modified example.

FIG. 12 is a configuration view illustrating an arrangement of an upward light guide plate 40 and laser light sources 21_{R}, 21_{G}, and 21_{B} used in a surface light source device 140 according to a fourth modified example.

FIG. 13 is an explanatory diagram for describing thickness conditions of the upward light guide plate 40 used in the surface light source device 140 according to the fourth modified example.

FIG. 14 is an explanatory diagram for describing behavior of a beam traveling inside the upward light guide plate 40 in the vicinity a connection portion 200 which is used in the surface light source device 140 according to the fourth modified example.

FIG. 15 is a view illustrating a state in which a casing 30 of the surface light source device 100 according to the first embodiment of the present invention is detached, when viewed from the back side.

FIG. 16 is a view illustrating a state in which a reflection sheet 60 of the surface light source device 100 according to the first embodiment of the present invention is detached, when viewed from the front side.

FIG. 17 is a cross-sectional view illustrating an assembled state of the surface light source device 100 according to the first embodiment of the present invention.

### MODE FOR CARRYING OUT THE INVENTION

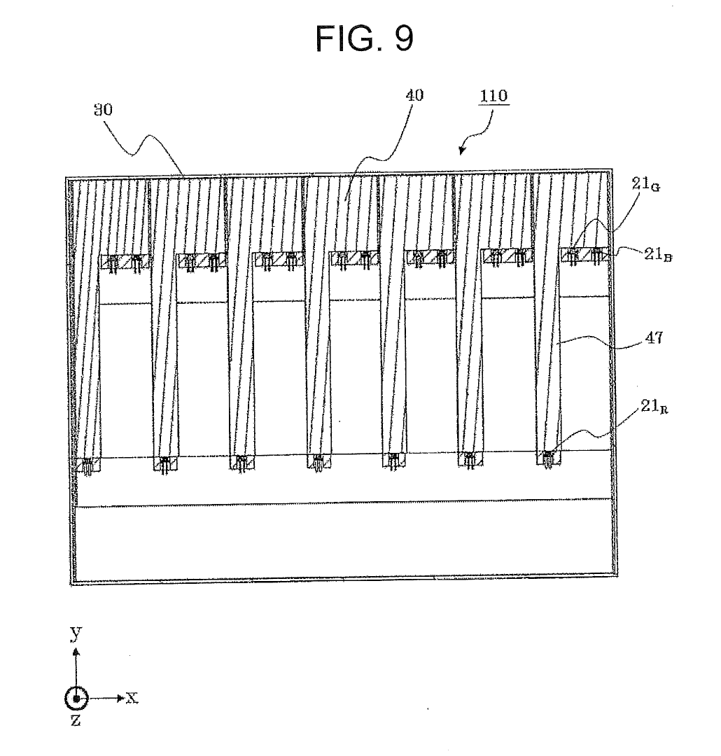

In recent years, performance of blue light emitting diodes (hereinafter referred to as LEDs) has been dramatically improved. Accordingly, surface light source devices employing single-color LEDs of three primary colors as light sources have been devised (e.g., Japanese Patent Application Publication No. 2010-101989 (paragraphs 0113 and 0115, FIG. 9), hereinafter referred to as a prior literature).

The prior literature shows a display device in which single-color light emitted from LED light sources 100, 101, and 102 is caused to enter a light-source-side light guide plate 103 to be reflected on triangular prisms 138 and 139, and then is caused to enter an image-display-side light guide plate 106 to be emitted from an emission opening surface 106a as planar light. A component in a shorter side direction of the cross section of the light-source-side light guide plate 103 of light incident on the light-source-side light guide plate 103 travels while repeatedly undergoing total reflection in the light guide plate, whereas a component in a longer side direction of the cross section of the light-source-side light guide plate 103 travels without being reflected in the light guide plate.

On the other hand, the laser shows very high monochromaticity. Thus, the liquid crystal display device using the laser can provide an image having a wide range of color reproduction. That is, the liquid crystal display device using the laser can significantly improve image quality.

The laser, however, also emits point-shaped light like the LED. Thus, the surface light source device using the laser as a light source also needs an optical system for converting laser light as the point-shaped light to the planar light, in the same manner as the LED. As this optical system, a flat-plate-shaped light guide element is used, for example. Laser light beams incident on an end portion of the light guide element are mixed while traveling inside the light guide element to become the linear light. This linear light is caused to enter a light guide plate and to be successively emitted to the outside so that the planar light is formed.

An optical system that converts the point-shaped light to the planar light, however, has a problem that an optical loss occurs to degrade luminance.

For example, it is conceivable that the optical loss occurs in sending light from the light guide element to a reflective member. Here, the light guide element converts the point-shaped light to the linear light. This light guide element corresponds to the light-source-side light guide plate 103 of the prior literature.

Moreover, for example, it is conceivable that the optical loss occurs due to leakage of light that does not satisfy a total reflection condition to the outside of the reflective member in reflecting light on the reflective member. Here, the reflective member corresponds to the prisms 138 and 139 of the prior literature.

Moreover, for example, it is conceivable that the optical loss occurs in sending light from the reflective member to the light guide plate. Here, the light guide plate corresponds to the image-display-side light guide plate 106 of the prior literature.

The invention described in the following embodiment has been made in view of the above, and provides a surface light source device that suppress a decrease of luminance even in a case where the planar light is generated by superimposing light beams emitted from a plurality of light sources.

That is, the following embodiment also describes the surface light source device that can suppress the decrease of luminance even in the case where the planar light is generated by superimposing the light beams emitted from the plurality of light sources.

Moreover, instead of the single-color LED described above, a white LED is used as a light source in some cases.

A light source of the white LED includes a blue LED and a fluorescent material. This fluorescent material absorbs light emitted from the blue LED and emits light serving as a complementary color of blue. Such an LED is referred to as the white LED. The complementary color of blue is yellow, which is a color including green and red.

Due to this configuration, the white LED has drawbacks of a wide wavelength bandwidth and a narrow range of color reproduction.

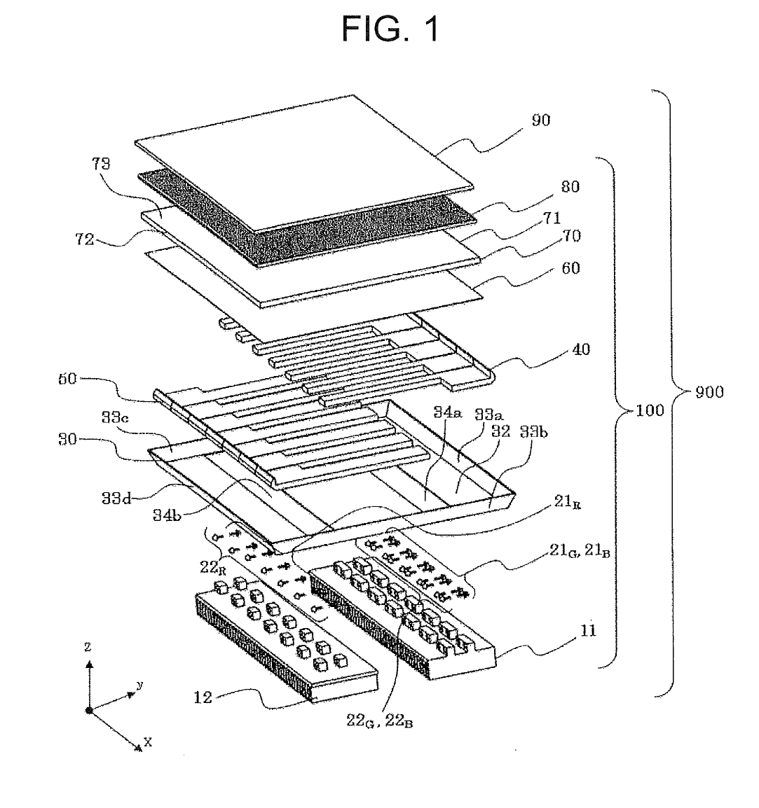

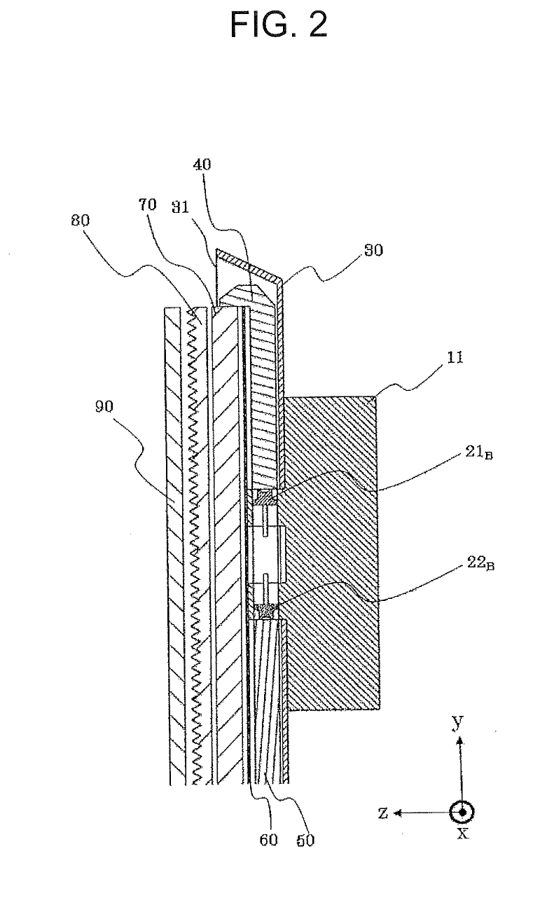

Moreover, as shown in Japanese Patent No. 2006-267936 (paragraphs 0009 and 0012, FIGS. 1 and 2), to improve a cooling function of the LED, a material having high thermal conductivity, such as aluminium, is used for a frame to which the LED is fixed.

Like the LED, the laser also needs to be cooled. As to the laser, its photoconversion efficiency is significantly reduced as the temperature rises. Thus, in addition to measures for heat dissipation of the laser itself, appropriate measures for reducing an increase in the ambient temperature of the laser are required.

In particular, if the laser of red color (hereinafter referred to as the red laser) continuously emits light with high power at high temperatures, degradation is accelerated and the lifetime is shortened. To prevent this, it is necessary to prevent heat generated by light sources of other colors from affecting a temperature rise of a light source of the red laser (hereinafter referred to as a red laser light source). That is, in a light source device including the red laser, it is effective to reduce transfer of heat generated by other light sources to the red laser light source.

To achieve this, for example, it is conceivable that the red laser light source is disposed in a position away from the other light sources.

It is also conceivable that a barrier component for blocking transfer of heat is disposed between the red laser light source and the other light sources. The “barrier” means a wall for separation or an obstruction. That is, it is conceivable that a component serving as a separator for preventing the transfer of heat is disposed between the red laser light source and the other light sources. The “separation” means partitioning. The “partitioning” means that an object with a certain size is divided into several parts with a boundary. Moreover, the “partitioning” means providing a boundary.

This barrier component can reduce transfer of heat caused by convection of warmed air. The barrier component can reduce transfer of heat by heat radiation (radiant heat) emitted from the light source. Heat in a region surrounded by the barrier component can be dissipated to the outside of the surface light source device. The barrier component may be a barrier portion that is formed by a part of a component.

The “image light” means light including image information. The liquid crystal display element is also referred to as the liquid crystal panel. The surface light source device used in the liquid crystal display device is also referred to as the backlight device.

In the following embodiment, the surface light source device will be described as a backlight of the liquid crystal display device. The surface light source device described below, however, can also be used as an illumination device for illuminating space such as a room, for example. Moreover, the surface light source device can also be used as an illumination device that illuminates a picture, a photograph or the like that is drawn on a film or the like from the back side. Moreover, the surface light source device can also be used as an illumination for a signboard that can also be seen at night or the like. In these cases, the planar light of color other than white can be produced by selecting colors used for the light source.

### FIRST EMBODIMENT

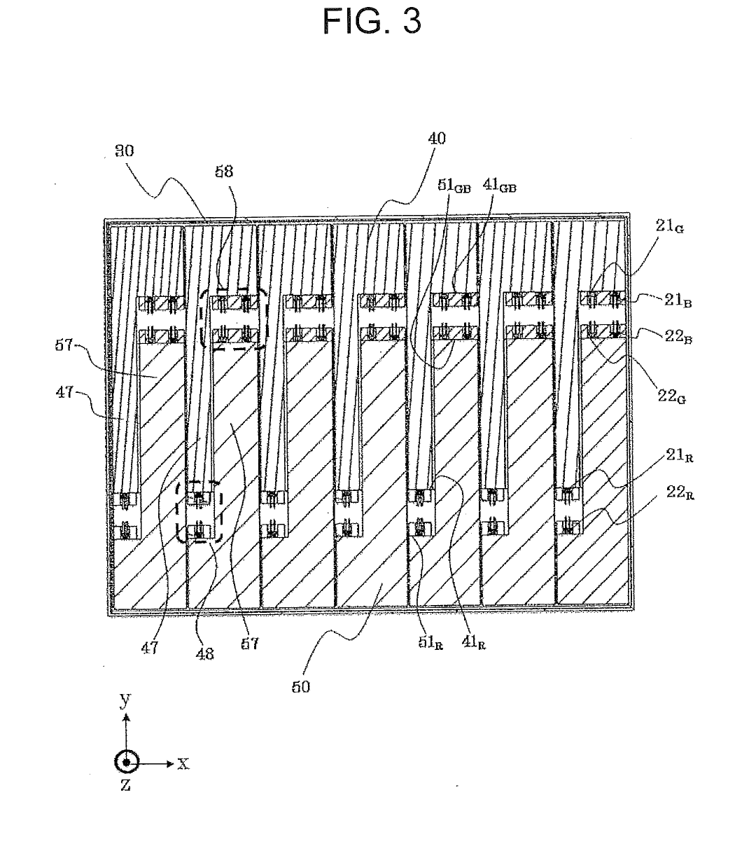

FIG. 1 is an exploded view illustrating a configuration of a liquid crystal display device 900 according to a first embodiment. FIG. 1 is also the exploded view illustrating a configuration of a surface light source device 100 according to the first embodiment. FIG. 2 is a partial cross-sectional view illustrating an assembled state of the surface light source device 100 according to the first embodiment. FIG. 3 is a schematic view illustrating an arrangement of light guide plates 40 and 50 and laser light sources 21 and 22 of the surface light source device 100 according to the first embodiment.

A surface of the surface light source device 100 from which the planar light is emitted has, for example, a rectangular shape. The surface of the surface light source device 100 from which the planar light is emitted is referred to as a light emission surface. Surfaces of other optical components from which light is emitted is also referred to as the light emission surfaces. The light emission surface is also simply referred to as an emission surface.

To facilitate explanation, coordinate axes of an xyz orthogonal coordinate system are shown in the drawings. In the following explanation, a direction of a longer side of the light emission surface of the surface light source device 100 is an x-axis, and a direction of a shorter side of the light emission surface is a y-axis. The y-axis direction is a direction in which the laser light sources 21 and 22 emit light. A direction perpendicular to an x-y plane is a z-axis. The z-axis direction is a thickness direction of the surface light source device.

In general, a display surface of the liquid crystal display device 900 is long in a horizontal direction and is short in a vertical direction, in a state where the liquid crystal display device 900 is placed. Thus, the following explanation will be given on a case where the surface light source device 100 is placed while the direction of the longer side of the light emission surface is the horizontal direction. In this case, the direction of the shorter side of the light emission surface is the vertical direction.

When the surface light source device 100 is viewed from the light emission surface side thereof, the right direction is a +x-axis direction. When the surface light source device 100 is viewed from the light emission surface thereof, the left direction is a −x axis direction. In a state where the surface light source device 100 is placed, the upward direction is a +y-axis direction. The +y-axis direction is a direction in which the warmed air rises. In the state where the surface light source device 100 is placed, the downward direction is a −y axis direction. The direction in which beams are emitted from the light emission surface (front side direction) is a +z-axis direction. The +z-axis direction is a direction in which the surface light source device 100 emits the planar light. The +z-axis direction is the front side direction of the surface light source device 100. The back side direction of the surface light source device 100 is a −z axis direction.

In the following explanation of the embodiment, the laser light sources 21_{R}, 21_{G}, and 21_{B} are sometimes referred to as the laser light sources 21, for example. In such cases, the laser light sources 21 collectively represent the laser light sources 21_{R}, 21_{G}, and 21_{B}.

The surface light source device 100 according to the first embodiment includes laser light sources 21_{R}, 21_{G}, 21_{B}, 22_{R}, 22_{G}, and 22_{B} and light guide plates 40, 50, and 70. Moreover, the surface light source device 100 can include heat dissipators 11 and 12, a casing 30, and a reflection sheet 60 or an optical sheet 80.

### <Laser Light Sources 21 and 22>

The laser light sources 21 and 22 include lasers of three colors, for example. The laser light sources 21_{R} and 22_{R} are red laser light sources. The laser light sources 21_{G} and 22_{G} are green laser light sources. The laser light sources 21_{B} and 22_{B} are blue laser light sources.

The laser light sources 21_{R}, 21_{G}, and 21_{B} emit beams in the +y-axis direction. The laser light sources 22_{R}, 22_{G}, and 22_{B} emit beams in the −y axis direction.

The beams emitted from the laser light sources 21_{R}, 21_{G}, and 21_{B} are incident on the light guide plate 40. The beams emitted from the laser light sources 22_{R}, 22_{G}, and 22_{B} are incident on the light guide plate 50.

### <Light Guide Plates 40 and 50>

The light guide plates 40 and 50 guide the beams emitted from the laser light sources 21 and 22 to the light guide plate 70. The light guide plate 40 guides laser beams 25 emitted from the laser light sources 21 to the light guide plate 70. The light guide plate 50 guides laser beams 26 emitted from the laser light source 22 to the light guide plate 70.

The light guide plate 40 receives beams emitted upward (in the +y-axis direction), and thus, is hereinafter referred to as an “upward light guide plate”. The light guide plate 50 receives beams emitted downward (in the −y axis direction), and thus, is hereinafter referred to as a “downward light guide plate.”

The light guide plates 40 and 50 are made of a material that is transmissive to light. That is, the light guide plates 40 and 50 are made of a transparent material. Here, the transparent material is, for example, an acrylic resin (PMMA), a polycarbonate resin (PC) or the like.

Moreover, the light guide plates 40 and 50 can have a diffusion structure in a part that receives light or a part that emits light. The diffusion structure may be a geometric structure such as recesses and projections. The diffusion structure may also be a structure including a diffusion material. Here, the diffusion material is a material having a higher refractive index than that of the transparent material of the light guide plates 40 and 50. The diffusion material is, for example, spherical beads and so on.

Each of the light guide plates 40 and 50 has a plate shape. For example, each of the light guide plates 40 and 50 has a thin plate shape. The plate shape includes two surfaces and side surfaces connecting the two surfaces. The two surfaces of the plate shape are hereinafter simply referred to as “surfaces.”

FIG. 3 illustrates an arrangement of the upward light guide plate 40, the downward light guide plate 50, and the light sources 21 and 22.

One upward light guide plate 40 and one downward light guide plate 50 constitute a pair. The pair of the upward light guide plate 40 and the downward light guide plate 50 is disposed on a plane parallel to the x-y plane. That is, the two surfaces of each of the light guide plates 40 and 50 are parallel to the x-y plane.

The laser light sources 21_{R}, 21_{G}, and 21_{B} are disposed on a surface of the upward light guide plate 40 which faces in the −y axis direction (incidence surface 41). The laser light sources 22_{R}, 22_{G}, and 22_{B} are disposed on a surface of the downward light guide plate 50 which faces in the +y-axis direction (incidence surface 51).

As described above, each of the light guide plates 40 and 50 has the plate shape. For example, the incidence surfaces 41 and 51 of the light guide plates 40 and 50 are formed on the side surfaces of the plate shapes of the light guide plates 40 and 50.

The laser light sources 21_{R}, 21_{G}, and 21_{B} are disposed so as to face the side surface of the light guide plate 40 which faces in the −y axis direction. The laser light sources 22_{R}, 22_{G}, and 22_{B} are disposed so as to face the side surface of the light guide plate 40 which faces in the +y-axis direction.

The laser beams 25 and 26 incident on the light guide plates 40 and 50 travel inside the light guide plates 40 and 50 while undergoing the total reflection. The laser beams 25 and 26 travel while undergoing the total reflection between the two surfaces of the plate shapes of the light guide plates 40 and 50.

Moreover, the diffusion structures of the light guide plates 40 and 50 can change angles of divergence of the laser beams 25 and 26. The “angle of divergence” is the angle at which light spreads.

Regarding the laser beams 25 and 26 traveling inside the light guide plates 40 and 50, adjacent laser beams 25 and 26 are mixed while traveling inside the light guide plates 40 and 50. The laser beams 25 and 26 that have travelled through the light guide plates 40 and 50 are emitted from emission surfaces 42 and 52 of the light guide plates 40 and 50, as the linear light having increased uniformity of light intensity.

Moreover, as shown in the first embodiment, in a case where light beams emitted from the light sources 21_{R}, 21_{G}, and 21_{B} are mixed to produce white color, the light emitted from the emission surface 42 of the light guide plate 40 is linear white light. In a case where light beams emitted from the light sources 22_{R}, 22_{G}, and 22_{B} are mixed to produce the white color, the light emitted from the emission surface 52 of the light guide plate 50 is linear white light.

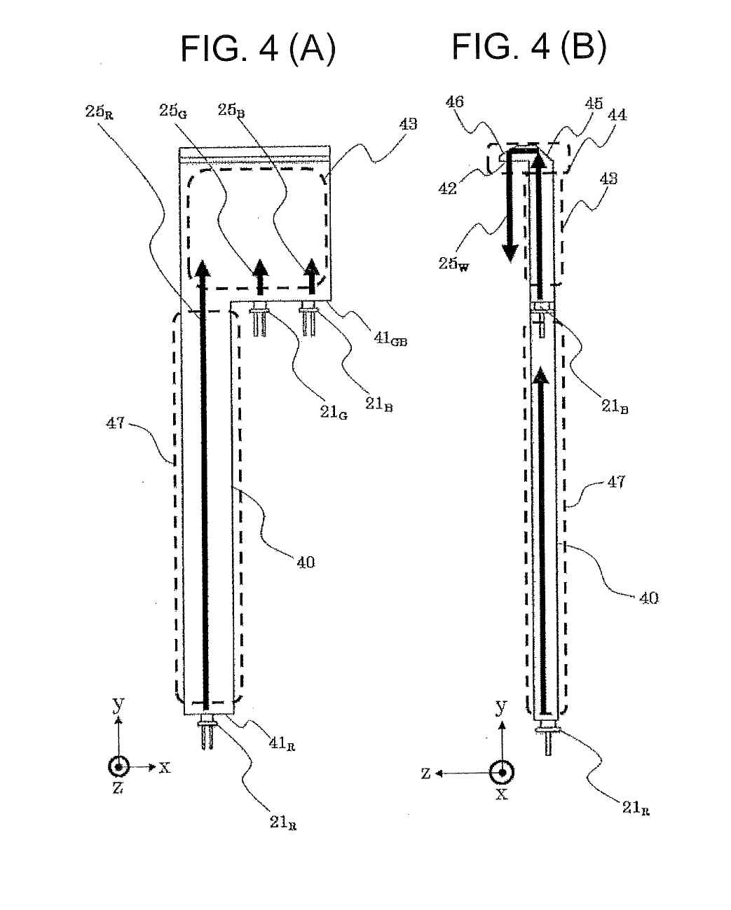

FIG. 4 is an explanatory diagram for describing behavior of light traveling in the upward light guide plate 40.

As illustrated in FIG. 4, the upward light guide plate 40 includes two incidence surfaces 41_{R} and 41_{GB}.

A laser beam 25_{R} emitted from the laser light sources 21_{R} is incident on the light guide plate 40 from the incidence surface 41_{R}. A laser beam 25_{G} emitted from the laser light sources 21_{G} is incident on the light guide plate 40 from the incidence surface 41_{GB}. A laser beam 25_{B} emitted from the laser light sources 21_{B} is also incident on the light guide plate 40 from the incidence surface 41_{GB}.

The incidence surface 41_{R} is located ahead of the incidence surface 41_{GB} in the −y axis direction. In the first embodiment, a light guide region 47 extending in the −y axis direction is formed ahead of the incidence surface 41_{GB} in the −x axis direction. An end of the light guide region 47 in the −y axis direction is the incidence surface 41_{R}.

In FIG. 4, since the light guide plate 40 has the plate shape, the incidence surfaces 41_{R} and 41_{GB} are the side surfaces of the light guide plate 40.

In the first embodiment, the laser light source 21_{R} is disposed so as to face the incidence surface 41_{R}. The laser light source 21_{G} is disposed so as to face the incidence surface 41_{GB}. The laser light source 21_{B} is disposed so as to face the incidence surface 41_{GB}.

In this configuration, the incidence surface 41_{R} is located in a position away from the incidence surface 41_{GB}. The laser light source 21_{R} is disposed in a position away from the laser light sources 21_{G} and 21_{B}. Thus, heat generated by the laser light sources 21_{G} and 21_{B} is not easily transferred to the laser light source 21_{R}. Moreover, heat generated by the laser light source 21_{R} is not easily transferred to the laser light sources 21_{G} and 21_{B}.

The heat generated by the laser light sources 21_{G} and 21_{B} is transferred in the +y-axis direction. The laser light source 21_{R} is disposed ahead of the laser light sources 21_{G} and 21_{B} in the −y axis direction. In general, the warmed air rises. That is, the warmed air moves in the +y direction. Thus, the heat generated by the laser light sources 21_{G} and 21_{B} is not easily transferred to the laser light source 21_{B.}

Between the laser light source 21_{R} and the laser light sources 21_{G} and 21_{B}, the light guide region 47 is disposed. Thus, the light guide region 47 prevents the heat generated by the laser light sources 21_{G} and 21_{B} from being transferred to the laser light source 21_{R}. Similarly, the light guide region 47 prevents the heat generated by the laser light source 21_{R} from being transferred to the laser light sources 21_{G} and 21_{B}. The light guide region 47 is a portion serving as a separator for preventing transfer of heat generated by the laser light sources 21_{R}, 21_{G}, and 21_{B} (barrier portion).

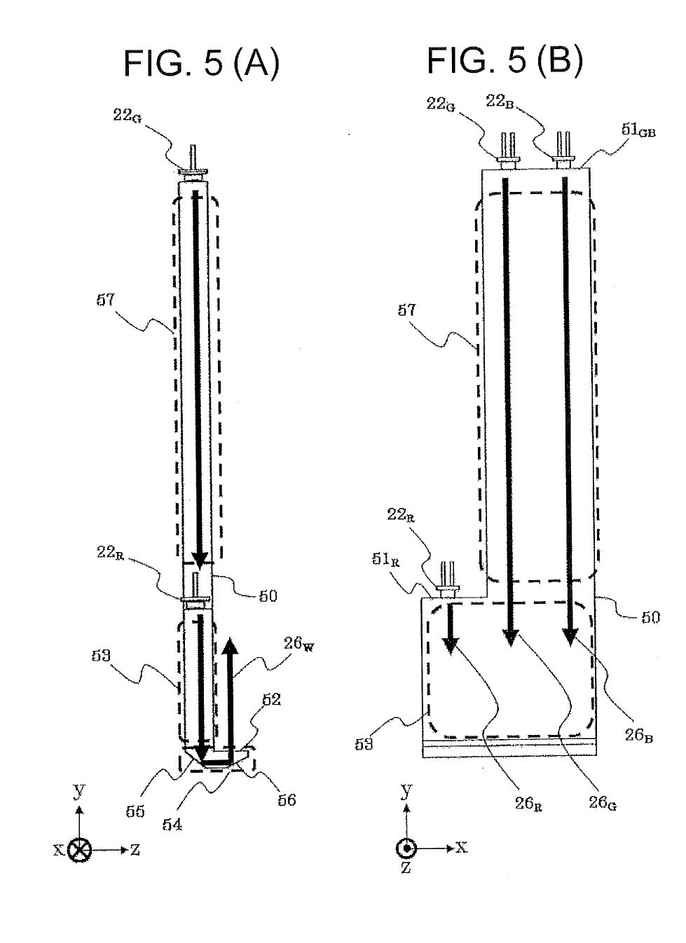

FIG. 5 is an explanatory diagram for describing behavior of light traveling in the downward light guide plate 50.

As illustrated in FIG. 5, the downward light guide plate 50 includes two incidence surfaces 51_{R} and 51_{GB}.

A laser beam 26_{R} emitted from the laser light source 22_{R} is incident on the light guide plate 50 from the incidence surface 51_{R}. A laser beam 26_{G} emitted from the laser light source 22_{G} is incident on the light guide plate 50 from the incidence surface 51_{G}B. A laser beam 26_{B} emitted from the laser light source 22_{B} is also incident on the light guide plate 50 from the incidence surface 51_{GB}.

The incidence surface 51_{R} is located ahead of the incidence surface 51_{G}B in the −y axis direction. In the first embodiment, a light guide region 57 extending in the +y-axis direction is formed ahead of the incidence surface 51_{R} in the +x-axis direction. An end of the light guide region 57 in the +y-axis direction is the incidence surface 51_{GB}.

In FIG. 5, since the light guide plate 50 has the plate shape, the incidence surfaces 51_{R} and 51_{GB} are the side surfaces of the light guide plate 50.

In the first embodiment, the laser light source 22_{R} is disposed so as to face the incidence surface 51_{R}. The laser light source 22_{G} is disposed so as to face the incidence surface 51_{GB}. The laser light source 22_{B} is disposed so as to face the incidence surface 51_{GB}.

In this configuration, the incidence surface 51_{R} is located in a position away from the incidence surface 51_{GB}. The laser light source 22_{R} is disposed in a position away from the laser light sources 22_{G} and 22_{B}. Thus, heat generated by the laser light sources 22_{G} and 22_{B} is not easily transferred to the laser light source 22_{R}. Moreover, heat generated by the laser light source 22_{R} is not easily transferred to the laser light sources 22_{G} and 22_{B}.

The heat generated by the laser light sources 22_{G} and 22_{B} is transferred in the +y-axis direction. The laser light source 22_{R} is disposed ahead of the laser light sources 22_{G} and 22_{B} in the −y axis direction. In general, the warmed air moves in the +y direction. Thus, the heat generated by the laser light sources 22_{G} and 22_{B} is not easily transferred to the laser light source 22_{R}.

Between the laser light source 22_{R} and the laser light sources 22_{G} and 22_{B}, the light guide region 57 is disposed. Thus, the light guide region 57 prevents the heat generated by the laser light sources 22_{G} and 22_{B} from being transferred to the laser light source 22_{R}. Similarly, the light guide region 57 prevents the heat generated by the laser light source 22_{R} from being transferred to the laser light sources 22_{G} and 22_{B}. The light guide region 57 is a portion serving as a separator for preventing transfer of heat generated by the laser light sources 22_{R}, 22_{G}, and 22_{B} (barrier portion).

As illustrated in FIG. 3, one upward light guide plate 40 and one downward light guide plate 50 constitute a pair. The light guide regions 47 are disposed side by side on the side in the −x axis direction of the light guide region 57. A gap in the x-axis direction between the light guide region 47 and the light guide region 57 is set to be small. This gap is such a narrow interval that the transfer of heat can be prevented. For example, the gap is about 2 mm or less. The gap is 2 mm or less. Here, the transfer of heat is caused by the convection of the warmed air, for example.

The laser light source 21_{R} and the laser light source 22_{R} are disposed in a region 48. The region 48 is surrounded by the incidence surface 41_{R}, the incidence surface 51_{R}, and side surfaces of the light guide regions 57.

Similarly, the laser light sources 21_{G} and 21_{B} and the laser light sources 22_{G} and 22_{B} are disposed in a region 58. The region 58 is surrounded by the incidence surface 41_{GB}, the incidence surface 51_{GB}, and side surfaces of the light guide regions 47.

In this manner, the laser light sources 21_{R} and 22_{R} are disposed in the region 48 different from the region 58 where the laser light sources 21_{G}, 21_{B}, 22_{G}, and 22_{B} are disposed. The laser light sources 21_{G}, 21_{B}, 22_{G}, and 22_{B} are disposed in the region 58 different from the region 48 where the laser light sources 21_{R} and 22_{R} are disposed. The regions 48 and 58 are surrounded by the incidence surfaces 41_{R}, 51_{R}, 41_{GB}, and 51_{GB} and the light guide regions 47 and 57.

The incidence surfaces 41_{R}, 51_{R}, 41_{GB}, and 51_{GB} and the light guide regions 47 and 57 of the regions 48 and 58 correspond to barrier portions.

With the foregoing configuration, the heat generated by the laser light sources 22_{G} and 22_{B} is not easily transferred to the laser light source 22_{R}. Similarly, the heat generated by the laser light source 22_{R} is not easily transferred to the laser light sources 22_{G} and 22_{B}.

Moreover, heat generated by the laser light sources 21 and 22 does not spread inside the surface light source device 100. Thus, the heat generated by the laser light sources 21 and 22 can be taken out of the surface light source device 100 with the small region. Accordingly, the cooling structure of the surface light source device 100 can be reduced in size. Moreover, heat dissipation design of the surface light source device 100 can be facilitated. In addition, heat dissipation design of the liquid crystal display device 900 can also be facilitated. Moreover, the heat generated by the laser light sources 21 and 22 can be efficiently released to the outside of the surface light source device 100.

As described above, the upward light guide plate 40 includes the emission surface 42. The downward light guide plate 50 includes the emission surface 52.

The upward light guide plate 40 includes a mixing region 43. The downward light guide plate 50 includes a mixing region 53.

The upward light guide plate 40 includes a reflection region 44. The downward light guide plate 50 includes a reflection region 54.

The mixing region 43 is optically located between the incidence surfaces 41_{R} and 41_{GB} and the emission surface 42. The mixing region 53 is optically located between the incidence surfaces 51_{R} and 51_{GB} and the emission surface 52.

The mixing region 43 is optically located between the incidence surfaces 41_{R} and 41_{GB} and the reflection region 44. The mixing region 53 is optically located between the incidence surfaces 51_{R} and 51_{GB} and the reflection region 54.

The reflection region 44 is optically located between the mixing region 43 and the emission surface 42. The reflection region 54 is optically located between the mixing region 53 and the emission surface 52.

The term “optically located” refers to a positional relationship on a path on which light travels. The “path” is the way of light. That is, even in a case where light is reflected on a mirror or the like so that the traveling direction thereof is changed, for example, the positional relationship is optically considered to be linear.

The emission surface 42 is optically connected to an incidence surface 71. For example, the emission surface 42 of the upward light guide plate 40 faces the incidence surface 71 of the light guide plate 70. The emission surface 52 is optically connected to an incidence surface 72. For example, the emission surface 52 of the downward light guide plate 50 faces the incidence surface 72 of the light guide plate 70.

The term “optically connected” refers to a state in which light emitted from one optical element is incident on another optical element. That is, even when two optical components are physically located away from each other, these optical components are connected as a path of light beams.

In the first embodiment, the incidence surfaces 41_{R}, 41_{GB}, 51_{R}, and 51_{GB} are surfaces parallel to a z-x plane. Moreover, in the first embodiment, the emission surfaces 42 and 52 are surfaces parallel to the z-x plane.

The incidence surface 41_{R} is disposed at the end of the light guide region 47 in the −y axis direction. The incidence surface 41_{GB} is disposed at an end of the mixing region 43 in the −y axis direction. A light guide region for guiding the laser beams 25_{G} and 25_{B} may be provided between the incidence surface 41_{GB} and the mixing region 43.

The incidence surface 51_{R} is disposed at an end of the mixing region 53 in the +y-axis direction. The incidence surface 51_{GB} is disposed at the end of the light guide region 57 in the +y-axis direction. A light guide region for guiding the laser beam 26_{R} may be provided between the incidence surface 51_{R} and the mixing region 53.

The light guide plates 40 and 50 are an example of light guide elements for converting the point-shaped light to the linear light. Other examples will be described later.

### <Heat Dissipators 11 and 12>

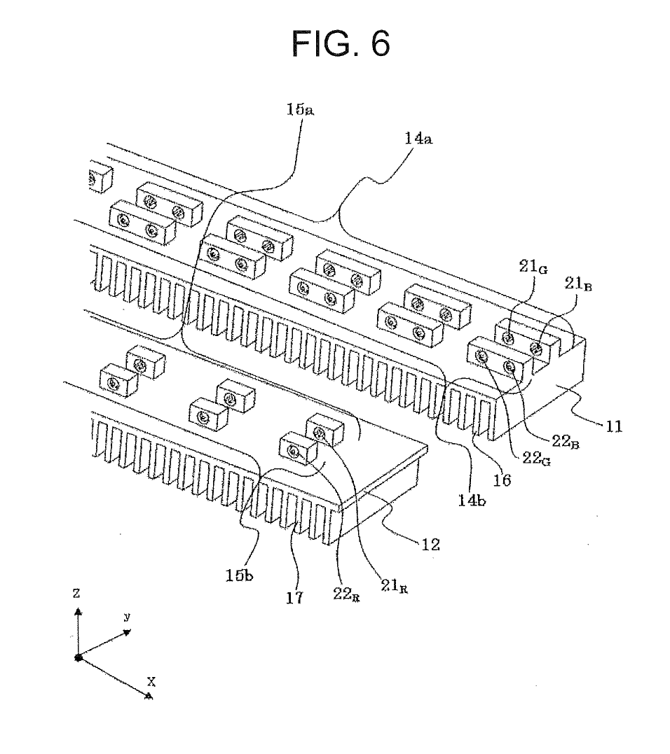

FIG. 6 is a perspective view illustrating a configuration of the heat dissipators 11 and 12.

The laser light sources 21 and 22 are attached to the heat dissipators 11 and 12. The laser light sources 21_{G}, 21_{B}, 22_{G}, and 22_{B} are attached to the heat dissipator 11. The laser light sources 21_{R} and 22_{R} are attached to the heat dissipator 12.

The heat dissipator 11 is disposed ahead of the heat dissipator 12 in the +y-axis direction.

Heat generated by the laser light sources 21_{G}, 21_{B}, 22_{G}, and 22_{B} is dissipated by the heat dissipator 11. Heat generated by the laser light sources 21_{R} and 22_{R} is dissipated by the heat dissipator 12.

As described above, the laser light sources 21_{G}, 21_{B}, 22_{G}, and 22_{B} are disposed in the region 58. The laser light sources 21_{R} and 22_{R} are disposed in the region 48. Thus, heat released to the region 58 is released by the heat dissipator 11 to the outside of the surface light source device 100. Heat released to the region 48 is released by the heat dissipator 12 to the outside of the surface light source device 100.

For example, in a case where the casing 30 has holes 34 in parts corresponding to holders 14 and 15, the casing 30 is disposed on the −z axis sides of the regions 48 and 58. Even in this case, by thermally connecting heat dissipation portions 16 and 17 to the casing 30, it is possible to suppress the spreading of heat released from the regions 48 and 58 to the outside of the regions 48 and 58 through the casing 30.

The term “thermally connecting” refers to a state in which heat is transferred. The “thermally connecting” generally refers to a state in which heat is transferred mainly by thermal conduction. Thus, even in a case where a material having high thermal conductivity or the like is sandwiched between two components, these two components can be thermally connected.

As illustrated in FIG. 1, a hole 34a is a hole through which holders 14a and 14b are inserted together. A hole 34b is a hole through which holders 15a and 15b are inserted together. Thus, surfaces of the heat dissipators 11 and 12 are disposed on the -z axis sides of the regions 48 and 58. The surfaces of the heat dissipators 11 and 12 which are in contact with the casing 30 are disposed on the −z axis sides of the regions 48 and 58. The “contact” refers to touching and being brought into contact with a portion. The surfaces of the heat dissipation portions 16 and 17 at the +z-axis sides are disposed on the -z axis sides of the regions 48 and 58.

The heat dissipators 11 and 12 are made of a material having high thermal conductivity. The material of the heat dissipators 11 and 12 is aluminium, brass and so on, for example.

The heat dissipators 11 and 12 include the holders 14 and 15 and the heat dissipation portions 16 and 17. The holders 14 and 15 hold the laser light sources 21 and 22. The heat dissipation portions 16 and 17 include heat dissipating fins.

In the first embodiment, surfaces of the heat dissipation portions 16 and 17 on the sides of the holders 14 and 15 are in contact with the outer surface of the casing 30.

In the first embodiment, the holders 14 and 15 are integrally formed with the heat dissipation portions 16 and 17. However, the holders 14 and 15 and the heat dissipation portions 16 and 17 may be constituted by different components as long as the holders 14 and 15 are thermally connected to the heat dissipation portions 16 and 17.

The heat dissipator 11 includes the holders 14a and 14b. The heat dissipator 12 includes the holders 15a and 15b. The holders 14a, 14b, 15a, and 15b are arranged at regular intervals in the x-axis direction. The holders 14a, 14b, 15a, and 15b are arranged side by side in the x-axis direction.

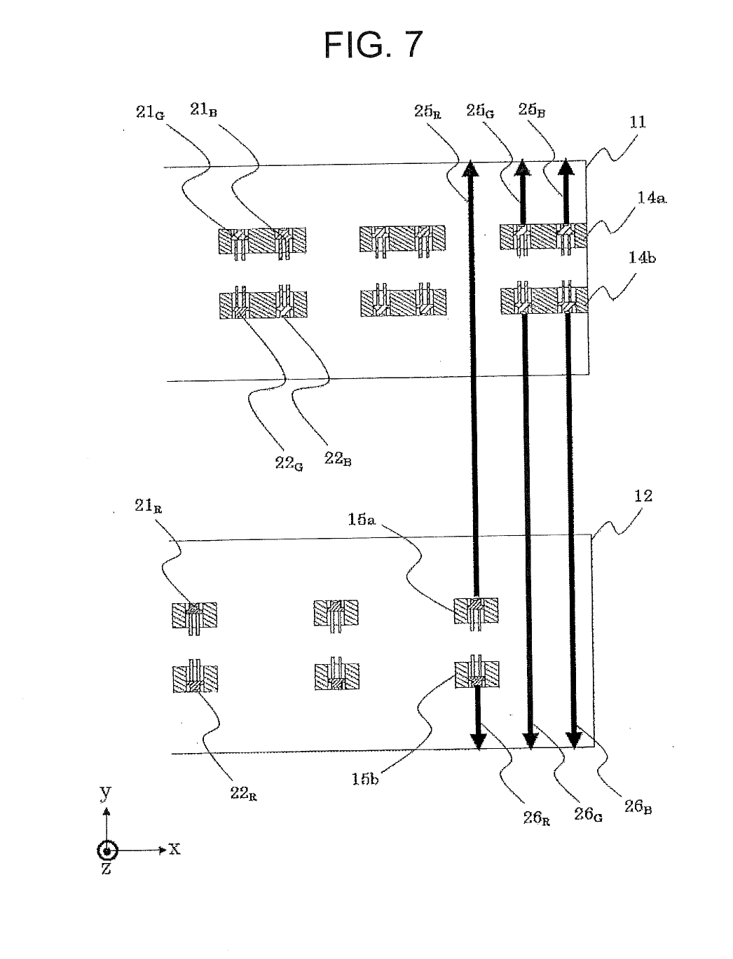

FIG. 7 is a cross-sectional view of the holders 14a, 14b, 15a, and 15b when the heat dissipators 11 and 12 are seen from the +z-axis direction. FIG. 7 is a schematic view illustrating an arrangement of the laser light sources 21 and 22 and the laser beams 25 and 26.

The holders 14a are disposed at the same positions as the holders 14b in the x-axis direction. The holders 14a are disposed ahead of the holders 14b in the +y-axis direction. The number of the holders 14a is equal to the number of the holders 14b.

The holders 15a are disposed at the same positions as the holders 15b in the x-axis direction. The holders 15a are disposed ahead of the holders 15b in the +y-axis direction. The number of the holders 15a is equal to the number of the holders 15b.

The green laser light sources 21_{G} and the blue laser light sources 21_{B} are attached to the holders 14a. The green laser light source 22_{G} and the blue laser light source 22_{B} are attached to the holders 14b.

The laser light source 21_{G} emits the laser beam 25_{G} in the +y-axis direction. The laser light source 21_{B} emits the laser beam 25_{B} in the +y-axis direction. The laser light source 22_{G} emits the laser beam 26_{G} in the -y axis direction. The laser light source 22_{B} emits the laser beam 26_{B} in the -y axis direction.

Thus, in a case where terminals are provided on the opposite sides to the emission surfaces of the laser light sources 21_{G}, 21_{B}, 22_{G}, and 22_{B}, a substrate for supplying a power source and so on to the laser light sources 21_{G}, 21_{B}, 22_{G}, and 22_{B} can be a common component. That is, the laser light sources 21_{G}, 21_{B}, 22_{G}, and 22_{B} can be connected to one substrate.

The red laser light source 21_{R} is attached to the holder 15a. The red laser light source 22_{R} is attached to the holder 15b.

The laser light source 21_{R} emits the laser beam 25_{R} in the +y-axis direction. The laser light source 22_{R} emits the laser beam 26_{R} in the -y axis direction.

Thus, in a case where terminals are provided on the opposite sides to the emission surfaces of the laser light sources 21_{R} and 22_{R}, a substrate for supplying a power source and so on to the laser light sources 21_{R} and 22_{R} can be a common component. That is, the laser light sources 21_{R} and 22_{R} can be connected to one substrate.

That is, the green laser light sources 21_{G} and 22_{G} and the blue laser light sources 21_{B} and 22_{B} are attached to the heat dissipator 11. The green laser light sources 21_{G} and the blue laser light sources 21_{B} cause the laser beams 25_{G} and 25_{B} to enter the upward light guide plate 40. The green laser light source 22_{G} and the blue laser light source 22_{B} cause the laser beams 26_{G} and 26_{B} to enter the downward light guide plate 50.

The laser beams 25_{G} and 25_{B} emitted from the green laser light sources 21_{G} and the blue laser light sources 21_{B} are incident on the upward light guide plate 40. The laser beams 26_{G} and 26_{B} emitted from the green laser light source 22_{G} and the blue laser light source 22_{B} are incident on the downward light guide plate 50.

The red laser light sources 21_{R} and 22_{R} are attached to the heat dissipator 12. The red laser light source 21_{R} causes the laser beam 25_{R} to enter the upward light guide plate 40. The red laser light source 22_{R} causes the laser beam 26_{R} to enter the downward light guide plate 50.

The laser beam 25_{R} emitted from the red laser light source 21_{R} is incident on the upward light guide plate 40. The laser beam 26_{R} emitted from the red laser light source 22_{R} is incident on the downward light guide plate 50.

The laser light sources 21_{G}, 21_{B}, 22_{G}, and 22_{B} are disposed so as not to block the laser beam 25_{R}. The laser light sources 21_{R} and 22_{R} are disposed so as not to block the laser beams 26_{G} and 26_{B}. In FIG. 7, the laser light sources 21_{G}, 21_{B}, 22_{G}, and 22_{B} are disposed ahead of the laser beams 25_{R} in the +x-axis direction. The laser light sources 21_{R} and 22_{R} are disposed ahead of the laser beams 26_{G} and 26_{B} in the −x axis direction.

The laser light sources 21_{G}, 21_{B}, 22_{G}, and 22_{B} are attached to the holders 14a and 14b of the heat dissipator 11. The laser beams 25_{G}, 25_{B}, 26_{G}, and 26_{B} are emitted from the laser light sources 21_{G}, 21_{B}, 22_{G}, and 22_{B.}

The laser light sources 21_{R} and 22_{R} are attached to the holders 15a and 15b of the heat dissipator 12. The laser beams 25_{R} and 26_{R} are emitted from the laser light sources 21_{R} and 22_{R}.

### <Reflection Sheet 60>

The reflection sheet 60 reflects light. That is, the reflection sheet 60 is not transmissive to light. The reflection sheet 60 has, for example, a sheet shape. The reflection sheet 60 is, for example, a sheet having a surface which reflects light. Further, the reflection sheet 60 may also have a plate shape. The reflection sheet 60 may also have a film shape. That is, it can be said that the reflection sheet 60 is an example of a reflective member.

The reflection sheet 60 is disposed ahead of the light guide plate 70 in the −z axis direction. That is, the reflection sheet 60 is disposed on the side opposite to an emission surface 73 with respect to the light guide plate 70. The reflection sheet 60 is disposed on the side opposite to the direction in which the planar light is emitted, with respect to the light guide plate 70. The reflection sheet 60 is disposed on the back side of the light guide plate 70.

The reflection sheet 60 is disposed ahead of the mixing regions 43 and 53 and the light guide regions 47 and 57 of the light guide plates 40 and 50 in the +z-axis direction. The reflection sheet 60 is disposed between the light guide plates 40 and 50 and the light guide plate 70, for example.

The reflection sheet 60 reflects light which has been emitted from the light guide plate 70 in the −z axis direction, thereby causing the light to travel in the +z-axis direction. The reflection sheet 60 reflects light which has been emitted from the light guide plate 70 to the back side, thereby causing the light to travel toward the front side. In this manner, light emitted from the light guide plate 70 can be effectively used.

The reflection sheet 60 may be a light reflection sheet using a resin such as polyethylene terephthalate as a base material, for example.

### <Light Guide Plate 70>

The light guide plate 70 converts the linear light emitted from the light guide plates 40 and 50 to the planar light.

The light guide plate 70 includes a front surface and a back surface. The front surface is a surface facing in the +z-axis direction. The back surface is a surface facing in the −z axis direction. The front surface and the back surface are, for example, plane surfaces parallel to each other. The front surface is the emission surface 73.

The light guide plate 70 has a flat plate shape, for example. In the first embodiment, the light guide plate 70 has a thin plate shape. The plate shape includes two surfaces and side surfaces connecting these two surfaces. One of the two surfaces is the emission surface 73. In FIG. 1, out of the two surfaces, the surface facing in the +z-axis direction is the emission surface 73.

The light guide plate 70 has a rectangular shape, for example. Two adjacent sides constituting the surface of the light guide plate 70 are orthogonal to each other. In the first embodiment, the two adjacent sides are a longer side along the x-axis direction and a shorter side along the y-axis direction.

The emission surface 73 is the surface of the light guide plate 70 on the +z-axis side thereof. The surface opposite to the emission surface 73 is referred to as the back surface. That is, the two surfaces of the light guide plate 70 are the emission surface 73 (front surface) and the back surface.

The incidence surface 71 is the surface of the light guide plate 70 which faces in the +y-axis direction. The incidence surface 72 is the surface of the light guide plate 70 which faces in the −y axis direction. The incidence surfaces 71 and 72 are formed at ends of the light guide plate 70. The incidence surfaces 71 and 72 are formed in the side surfaces of the light guide plate 70, for example. The side surfaces are surfaces connecting the emission surface 73 to the back surface.

The light guide plate 70 is made of a transparent material. Here, the transparent material is an acrylic resin (PMMA), a polycarbonate resin (PC) or the like, for example.

On the surface of the light guide plate 70 which faces in the −z axis direction (back surface), for example, a minute uneven shape is formed. That is, on the surface of the light guide plate 70 which faces in the −z axis direction (back surface), micromachining is performed. The size of the uneven shape is, for example, on the order of microns.

Laser beams 25_{W} and 26_{W} travel inside the light guide plate 70 while repeatedly undergoing the total reflection. The total reflection of the laser beams 25_{W} and 26_{W} is repeated between the emission surface 73 and the back surface.

In the first embodiment, the laser beam 25_{W} travels in the −y axis direction inside the light guide plate 70. The laser beam 26_{W} travels in the +y-axis direction inside the light guide plate 70.

The traveling direction of the laser beams 25_{W} and 26_{W} traveling inside the light guide plate 70 is changed when the laser beams 25_{W} and 26_{W} are incident on the uneven shape. The laser beams 25_{W} and 26_{W} whose traveling directions have been changed do not satisfy the total reflection condition any more, and are emitted from the emission surface 73 of the light guide plate 70. The emission surface 73 is the surface of the light guide plate 70 which faces in the +z-axis direction.

The light guide plate 70 can include the diffusion material. Here, the diffusion material is a material having a refractive index higher than that of the transparent material of the light guide plate 70. The diffusion material is included in the transparent material. The “transparent material” herein is a material of a part of the light guide plate 70 that guides the laser beams 25_{W} and 26_{W}.

The laser beams 25_{W} and 26_{W} travel inside the light guide plate 70 while repeatedly undergoing the total reflection. The laser beams 25_{W} and 26_{W} traveling inside the light guide plate 70 are refracted when passing through the diffusion material. The traveling directions of the laser beams 25_{W} and 26_{W} that have been refracted when passing through the diffusion material are changed. The laser beams 25_{W} and 26_{W} whose traveling directions have been changed do not satisfy the total reflection condition any more, and are emitted from the emission surface 73 of the light guide plate 70.

The laser beams 25_{W} and 26_{W} that have entered from the incidence surfaces 71 and 72 of the light guide plate 70 are successively released to the outside from the emission surface 73 while traveling inside the light guide plate 70. Then, the planar light having increased uniformity in light intensity is formed. That is, the surface light source device 100 serves as a surface light source having a luminance with high uniformity. The surface light source device 100 serves as the surface light source with increased uniformity of luminance.

The light guide plate 70 is disposed at an opening 31 of the casing 30. The light guide plate 70 has a shape corresponding to the opening 31 of the casing 30. In the first embodiment, the light guide plate 70 is disposed so as to cover the opening 31 of the casing 30.

The light guide plate 70 is an example of a light guide element that converts the linear light to the planar light.

### <Other Configurations of Light Guide Plates 40, 50, and 70>

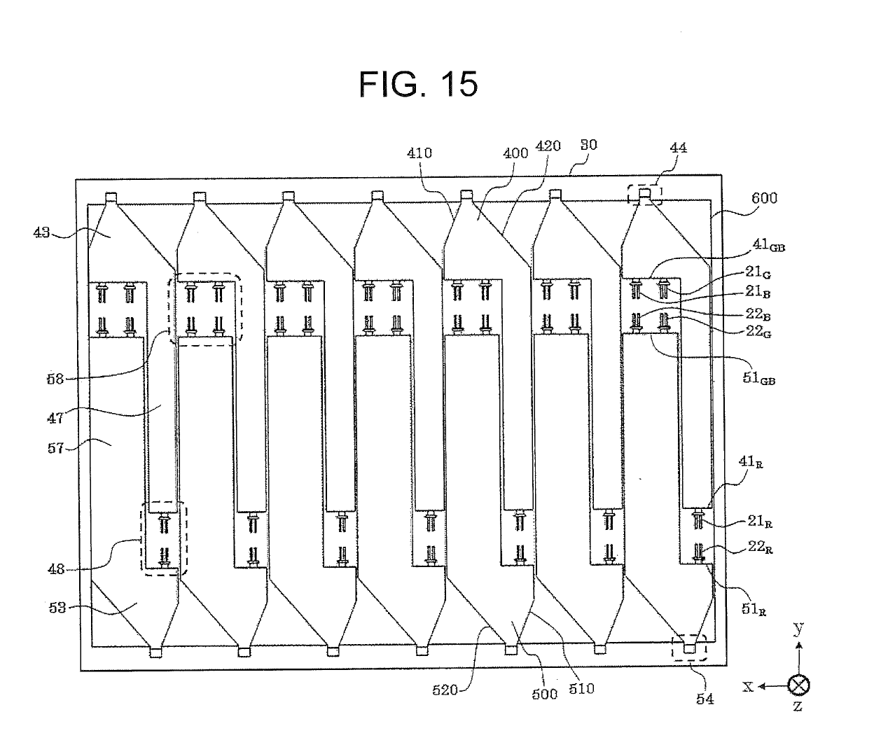

In the following, examples of a light guide element that converts the point-shaped light to the linear light and a light guide element that converts the linear light to the planar light will be described with reference to FIGS. 15, 16, and 17.

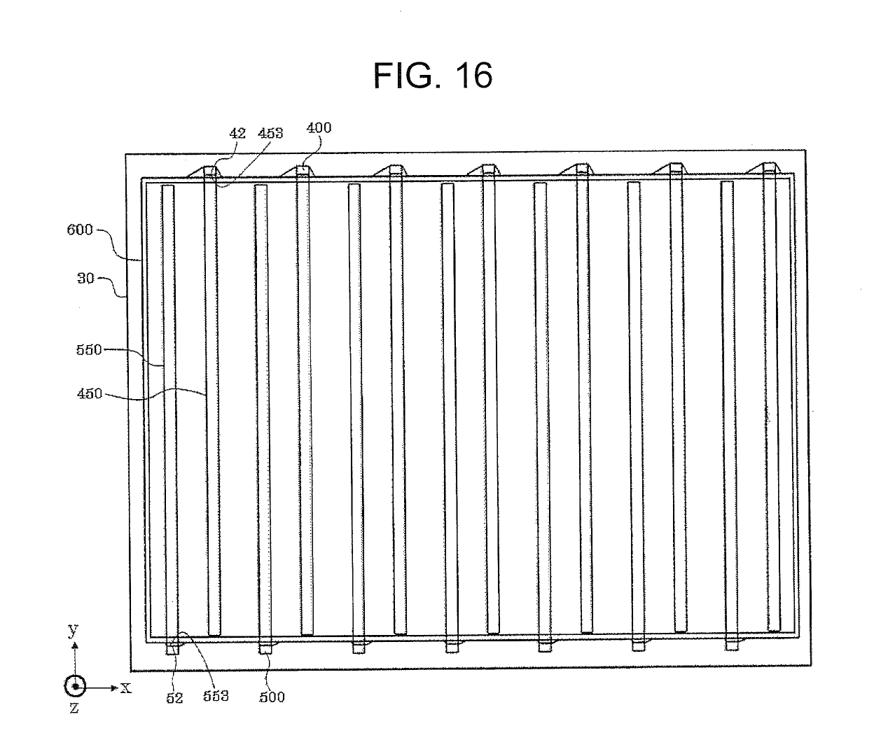

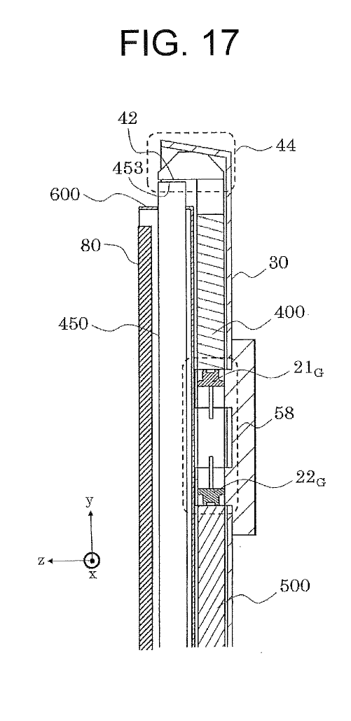

FIG. 15 is a view illustrating a state in which the casing 30 of the surface light source device 100 is detached, when viewed from the back side. FIG. 16 is a view illustrating a state in which the reflection sheet 60 of the surface light source device 100 is detached, when viewed from the front side. FIG. 17 is a cross-sectional view illustrating an assembled state of the surface light source device 100.

Another light guide element that converts the point-shaped light to the linear light will be described.

Light guide elements 400 and 500 have plate shapes similar to those of the light guide plates 40 and 50. In a manner similar to the light guide plates 40 and 50 illustrated in FIG. 3, the light guide elements 400 and 500 include light guide regions 47 and 57, mixing regions 43 and 53, and reflection regions 44 and 54. Each of the light guide elements 400 and 500 has a thin plate shape, for example.

The mixing regions 43 and 53 of the light guide elements 400 and 500 have shapes that are narrowed toward in the direction in which beams travel. That is, widths of the mixing regions 43 and 53 of the light guide elements 400 and 500 in the x-axis direction decrease in the direction in which beams travel. Each of the reflection regions 44 and 54 has a rod shape.

The light guide element 400 corresponds to the light guide plate 40. The light guide element 500 corresponds to the light guide plate 50. The light guide elements 400 and 500 are the same as the light guide plates 40 and 50 except that light incident on the mixing regions 43 and 53 is narrowed to enter the rod-shaped reflection regions 44 and 54. A width of light incident on the mixing regions 43 and 53 is a width in the x-axis direction in FIG. 15.

The light guide element 400 guides and mixes laser beams 25 emitted in the +y-axis direction. The light guide element 500 guides and mixes laser beams 26 emitted in the −y axis direction.

The laser light sources 21_{R}, 21_{G}, and 21_{B} are disposed on surfaces of the light guide element 400 which face in the −y axis direction. The laser light sources 22_{R}, 22_{G}, and 22_{B} are disposed on the surfaces of the light guide element 500 which face in the +y-axis direction.

The surfaces of the light guide element 400 which face in the −y axis direction and the surfaces of the light guide element 500 which face in the +y-axis direction are side surfaces. Incidence surfaces 41 and 51 of the light guide elements 400 and 500 are, for example, surfaces perpendicular to the x-y plane. The incidence surface 41 and the incidence surface 51 are disposed so as to face each other.

The light guide element 400 and the light guide element 500 constitute a pair. The pair of the light guide element 400 and the light guide element 500 is disposed on a plane parallel to the x-y plane. That is, two surfaces of each of the light guide elements 400 and 500 are parallel to the x-y plane.

The laser light sources 21 and 22 are disposed so as to face the incidence surfaces 41 and 51. The laser light sources 21 and 22 are disposed in the regions 48 and 58.

The region 48 is surrounded by the incidence surface 41_{R}, the incidence surface 51_{R}, and side surfaces of the light guide regions 57. Similarly, the region 58 is surrounded by the incidence surface 41_{G}B, the incidence surface 51_{GB}, and side surfaces of the light guide regions 47.

Light incident on the incidence surfaces 41 and 51 travels inside the light guide regions 47 and 57 to enter the mixing regions 43 and 53. Side surfaces of the mixing regions 43 and 53 of the light guide elements 400 and 500 have tilted surfaces 410, 420, 510, and 520 so that optical paths are narrowed as they advance in the directions in which the light beams travel. The side surfaces of the mixing regions 43 and 53 are, for example, surfaces perpendicular to the x-y plane.

A distance in the x-axis direction between the tilted surface 410 and the tilted surface 420 decreases in the direction in which the light beams travel (+y-axis direction). Similarly, a distance in the x-axis direction between the tilted surface 510 and the tilted surface 520 decreases in the direction in which the light beams travel (−y axis direction). The x-axis is parallel to the plane on which the light guide elements 400 and 500 are disposed (x-y plane) and is perpendicular to the direction in which the light beams travel (y-axis direction).

The tilted surfaces 410, 420, 510, and 520 are the side surfaces of the mixing regions 43 and 53. The mixing regions 43 and 53 are regions connecting the light guide regions 43 and 53 to the reflection regions 44 and 54.

Incident beams that have entered from the incidence surface 41 of the light guide element 400 are mixed in the mixing region 43. When laser beams 25_{R}, 25_{G}, and 25_{B} are mixed, the laser beams 25_{R}, 25_{G}, and 25_{B} are collected while being repeatedly reflected on the tilted surfaces 410 and 420. Similarly, when laser beams 26_{R}, 26_{G}, and 26_{B} are mixed, the laser beams 26_{R}, 26_{G}, and 26_{B} are collected while being repeatedly reflected on the tilted surfaces 510 and 520. Then, the collected laser beams 25 and 26 are incident on the reflection regions 44 and 54.

The laser beam 25 that has been incident on the reflection region 44 is reflected and thereby its traveling direction is changed. Then, the laser beam 25 reaches the emission surface 42. The laser beam 26 that has been incident on the reflection region 54 is reflected and thereby its traveling direction is changed. Then, the laser beam 25 reaches the emission surface 52.

The emission surfaces 42 and 52 of the reflection regions 44 and 54 are disposed so as to face incidence surfaces 453 and 553 of light guide elements 450 and 550. Emission beams 25_{W} and 26_{W} emitted from the reflection regions 44 and 54 reach the incidence surfaces 453 and 553 of the light guide elements 450 and 550.

Each of the light guide elements 450 and 550 has a rod shape.

The emission beams 25_{W} and 26_{W} emitted from the reflection regions 44 and 54 are incident on the light guide elements 450 and 550 from the incidence surfaces 453 and 553 of the rod-shaped light guide elements 450 and 550.

Each of the incidence surfaces 453 and 553 is formed at an end in a longitudinal direction of the rod shape. The incidence surface 453 is formed at the end of the light guide element 450 in the +y-axis direction. The incidence surface 553 is formed at the end of the light guide element 550 in the −y axis direction.

The laser beams 25_{W} and 26_{W} that have entered from the incidence surfaces 453 and 553 travel toward the other ends while being repeatedly reflected inside the light guide elements 450 and 550.

In a manner similar to the light guide element 70, each of the light guide elements 450 and 550 is made of a transparent material.

Each of the light guide elements 450 and 550 includes the diffusion material therein, for example. In a manner similar to the light guide plate 7, each of the light guide elements 450 and 550 can have an uneven shape on its side surface, instead of the diffusion material. The light guide elements 450 and 550 release light that have entered from the ends of the rod shapes (incidence surfaces 453 and 553) successively to the outside. In this manner, the light guide elements 450 and 550 produce the linear light.

Next, another light guide element that converts the linear light to the planar light will be described. This light guide element that converts the linear light to the planar light will be hereinafter referred to as a “reflection portion.”

The reflection portion 600 has a box shape. The reflection portion 600 includes, for example, a bottom plate portion, a side plate portion, and an opening. The bottom plate portion and the side plate portion are plate-shaped portions. The bottom plate portion is parallel to the x-y plane, for example. The side plate portion is parallel to the y-z plane or the z-x plane, for example. The opening is an opening portion provided in the direction of the normal of the bottom plate portion. The opening faces the bottom plate portion.

The side plate portion may be tilted so that a region surrounded by the side plate portion enlarges toward the opening. That is, in this case, a reflection surface of the side plate portion can be seen from the opening side.

The bottom plate portion is, for example, a plane surface having the same size as, or a smaller size than, a display surface of the liquid crystal display element 90. The bottom plate portion may be a curved surface.

An inner surface of the reflection portion 600 is a light reflection surface. The “inner surface” is an inner surface of the box shape of the reflection portion 600. In this reflection surface, a light reflection sheet using a resin such as polyethylene terephthalate as a base material can be provided on the inner surface of the reflective plate. The reflection surface may be a light reflection surface formed by depositing a metal on the inner surface of the reflection portion 600 by evaporation.

The optical sheet 80 is disposed on the +z-axis side of the reflection portion 600. The optical sheet 80 is disposed at the opening of the reflection portion 600 so as to face in the +z-axis direction. The optical sheet 80 is disposed so as to cover the opening. The reflection portion 600 and the optical sheet 80 constitute a hollow box shape.

The light guide elements 450 and 550 are disposed so as to penetrate the hollow box in the y-axis direction. The light guide elements 450 and 550 are disposed in a part surrounded by the bottom plate portion and the side plate portions. That is, the light guide elements 450 and 550 are disposed in a part surrounded by the reflection surfaces.

Specifically, the side plate portion on the +y-axis side and the side plate portion on the −y axis side have holes having the same size as that of the ends of the light guide elements 450 and 550 in the y-axis direction. Locations of the holes which are provided in the side plate portion on the +y-axis side and the side plate portion on the −y axis side and through which the light guide elements 450 and 550 are inserted, are on the same coordinate positions on the z-x plane.

The light guide elements 450 and 550 are inserted through the holes provided in the side plate portion on the +y-axis side and in the side plate portion on the −y axis side and thereby are attached to the reflection portion 600. The incidence surfaces 453 and 553 of the light guide elements 450 and 550 are disposed outside the side plate portions. That is, the incidence surfaces 453 and 553 of the light guide elements 450 and 550 are located outside the box shape of the reflection portion 600.

Laser beams 25_{W} and 26_{W} reflected or diffuse-reflected inside the light guide elements 450 and 550 spread inside the reflection portion 600. The laser beams 25_{W} and 26_{W} that have reached the bottom plate portion and the side plate portion are reflected on the reflection surface of the bottom plate portion and the reflection surface of the side plate portion. The laser beams 25_{W} and 26_{W} travel inside the reflection portion 600 while changing the traveling direction.

Similarly, Laser beams 25_{W} and 26_{W} emitted from the adjacent light guide elements 450 and 550 also travel inside the reflection portion 600. At this time, laser beams 25_{W} and 26_{W} emitted from the light guide elements 450 and 550 spatially overlap one another while traveling inside the reflection portion 600.

The reflection surface of the bottom plate portion and the reflection surface of the side plate portion may be reflection surfaces of mirror surfaces or diffusion reflection surfaces. In the case of diffusion reflection surfaces, the laser beams 25_{W} and 26_{W} are diffused when they are reflected and thereby spatial overlap between the laser beams 25_{W} and 26_{W} is promoted.

Laser beams 25_{W} and 26_{W} are emitted from the opening of the reflection portion 600 toward the optical sheet 80. The laser beams 25_{W} and 26_{W} emitted from the opening pass through the optical sheet 80 and irradiate the back surface of the liquid crystal display element 90.

### <Optical Sheet 80>

The optical sheet 80 further uniformizes the planar light emitted from the light guide plate 70. The optical sheet 80 increases uniformity of the planar light emitted from the light guide plate 70.

The light guide plate 70 is disposed so as to face the back surface of the optical sheet 80. That is, the optical sheet 80 is disposed so as to face the emission surface 73 of the light guide plate 70.

The optical sheet 80 transmits laser beams 25_{W} and 26_{W} entering from the back surface toward the front surface. When the optical sheet 80 transmits the laser beams 25_{W} and 26_{W}, the optical sheet 80 transmits only arbitrary polarized light and reflects the other polarized light.

The reflected light is reflected on the reflection sheet 60. The reflected light is diffused by the light guide plate 70. In this manner, the reflected light is diffused again so that the direction of polarization rotates. The reflected light is reflected again so that the direction of polarization rotates. Light whose direction of polarization has rotated travels in the +z-axis direction again and passes through the optical sheet 80.

Here, the front surface of the optical sheet 80 is a surface facing in the +z-axis direction. The back surface of the optical sheet 80 is a surface facing in the -z axis direction.

Laser beams 25_{W} and 26_{W} that have passed through the optical sheet 80 are planar light with increased uniformity of light intensity. That is, the laser beams 25_{W} and 26_{W} that have passed through the optical sheet 80 become planar illumination light whose in-plane luminance distribution in the x-y plane is uniform. The laser beams 25_{W} and 26_{W} that have passed through the optical sheet 80 become the planar illumination light having increased uniformity of the in-plane luminance distribution in the x-y plane.

The “in-plane luminance distribution” is a distribution showing the level of luminance with respect to a position represented in two dimensions in an arbitrary plane. Here, the in-plane is a range in which an image of the liquid crystal display element 90 is displayed.

The optical sheet 80 is made of a material that is transmissive to light. The optical sheet 80 has a sheet shape. The optical sheet 80 has, for example, a thin plate shape. The optical sheet 80 may have a plate shape. The optical sheet 80 may have a film shape.

The optical sheet 80 may be a diffusion sheet that diffuses light. The optical sheet 80 may be formed by superimposing a diffusion sheet and a polarizing sheet.

### <Casing 30>

The casing 30 has a box shape having the opening 31.

The casing 30 includes the light guide plates 40 and 50 therein. The casing 30 includes the light guide plate 70 at the opening 31. The casing 30 can include the reflection sheet 60 therein.

The casing 30 is formed by processing a sheet metal, for example. Alternatively, the casing 30 is formed by molding a resin, for example.

The casing 30 includes one bottom plate portion 32, four side plate portions 33 (33a, 33b, 33c, and 33d), and the opening 31. The opening 31 is formed by the side plate portions 33. The opening 31 faces the bottom plate portion 32.

In the first embodiment, the bottom plate portion 32 of the casing 30 is disposed parallel with the x-y plane.

The side plate portion 33a is disposed on the +y-axis side of the bottom plate portion 32. The side plate portion 33b is disposed on the +x-axis side of the bottom plate portion 32. The side plate portion 33c is disposed on the −x axis side of the bottom plate portion 32. The side plate portion 33d is disposed on the −y axis side of the bottom plate portion 32.

In the first embodiment, the side plate portion 33a is connected to an end of the bottom plate portion 32 in the +y-axis direction. The side plate portion 33b is connected to an end of the bottom plate portion 32 in the +x-axis direction. The side plate portion 33c is connected to an end of the bottom plate portion 32 in the −x axis direction. The side plate portion 33d is connected to an end of the bottom plate portion 32 in the −y axis direction. Ends of the side plate portion 33a, 33b, 33c, and 33d in the −z axis direction are connected to the bottom plate portion 32.

The bottom plate portion 32 of the casing 30 has the holes 34. For example, the holes 34 include two holes 34a and 34b. As illustrated in FIG. 1, the hole 34a is formed on a side of the bottom plate portion 32 in the +y-axis direction. The hole 34b is formed on a side of the bottom plate portion 32 in the −y axis direction.

The holders 14 and 15 of the heat dissipators 11 and 12 are inserted in the holes 34 from the −z axis direction. The heat dissipation portions 16 and 17 of the heat dissipators 11 and 12 are disposed on the back side of the bottom plate portion 32 of the casing 30 (side in the −z axis direction).

The holders 14 and 15 of the heat dissipators 11 and 12 are disposed inside the casing 30. The heat dissipation portions 16 and 17 of the heat dissipators 11 and 12 are disposed outside the casing 30.

In this case, the surfaces of the heat dissipation portions 16 and 17 which face the holders 14 and 15 are disposed on the −z axis sides of the regions 48 and 58. Thus, the heat released into the regions 48 and 58 is released to the outside of the surface light source device 100 from the heat dissipation portions 16 and 17. The heat released into the regions 48 and 58 is released to the outside of the casing 30 from the heat dissipation portions 16 and 17.

As described above, in the first embodiment, the region 48 is formed by the side surfaces of the light guide regions 57, the incidence surface 51_{R} of the light guide plate 50, the incidence surface 41_{R} of the light guide plate 40, the surface of the heat dissipation portion 17 which faces the holder 15, and the back surface of the reflection sheet 60. In a case where the reflection sheet 60 is not used, the back surface of the reflection sheet 60 can be replaced by the back surface of the light guide plate 70.

The region 58 is formed by the side surfaces of the light guide regions 47, the incidence surface 51_{GB} of the light guide plate 50, the incidence surface 41_{GB} of the light guide plate 40, the surface of the heat dissipation portion 16 which faces the holder 14, and the back surface of the reflection sheet 60. In a case where the reflection sheet 60 is not used, the back surface of the reflection sheet 60 can be replaced by the back surface of the light guide plate 70.

The holders 14a and 14b of the heat dissipator 11 are disposed in a state of projecting in the +z-axis direction from the hole 34a situated in the bottom surface portion 32 of the casing 30. Similarly, the holders 15a and 15b of the heat dissipator 12 are disposed in a state of projecting in the +z-axis direction from the hole 34b situated in the bottom surface portion 32 of the casing 30.

### <Liquid Crystal Display Element 90>

The liquid crystal display element 90 receives light emitted from the surface light source device 100 and emits image light. The image light is light including image information.

The liquid crystal display element 90 is disposed on the +z-axis side of the surface light source device 100.

The liquid crystal display element 90 illustrated in FIG. 1 has a rectangular shape, for example. The liquid crystal display element 90, however, may have a shape other than the rectangular shape.

The casing 30 and a frame-shaped component (not shown) sandwich, for example, the light guide plates 40 and 50, the reflection sheet 60, the light guide plate 70, the optical sheet 80, and the liquid crystal display element 90 in the z-axis direction and hold these components.

The “frame-shaped component” is a frame-shaped cabinet surrounding the liquid crystal display element 90. The “cabinet” here is an outer case of a television (display device).

The frame-shaped component has a shape which also has an opening in a bottom surface of a box shape having an opening. That is, the “frame-shaped component” has a hole in a part of the bottom surface of the box shape. The bottom surface is a surface opposite to the opening of the box shape. The hole (opening) formed in the part of the bottom surface is disposed at the center of the bottom surface, for example. The opening in the part of the bottom surface has a rectangular shape, for example. A size of this rectangular hole (opening) is substantially equal to a region where an image produced by the liquid crystal display element 90 is displayed. The opening in the part of the bottom surface is disposed not so as to block the region where the image is displayed. The frame-shaped component is a component covering a part of side surfaces of the liquid crystal display element 90.

The frame-shaped component is disposed so that the bottom surface thereof faces in the +z-axis direction. The frame-shaped component is attached to the casing 30 so that the liquid crystal display element 90, the light guide plates 40, 50, and 70, and so on are sandwiched in the +z-axis direction.

### <Behavior of Light in Surface Light Source Device 100>

Next, behavior of light in the surface light source device 100 will be described.

FIG. 4 is an explanatory diagram for describing behavior of light traveling in the upward light guide plate 40.

The laser beams 25_{R}, 25_{G}, and 25_{B} that have been incident on the upward light guide plate 40 from the incidence surfaces 41_{R} and 41_{GB} travel in the +y-axis direction.

As illustrated in FIG. 4, the red laser light source 21_{R} is disposed so as to face the incidence surface 41_{R} of the upward light guide plate 40. The red laser beam 25_{R} emitted from the red laser light source 21_{R} travels in the +y-axis direction while being reflected inside the light guide plate 40.

The laser beam 25_{R} is incident on the light guide region 47. The laser beam 25_{R} travels in the +y-axis direction in the light guide region 47. Then, the laser beam 25_{R} is incident on the mixing region 43 from the light guide region 47. The laser beam 25_{R} travels in the +y-axis direction in the mixing region 43.

On the other hand, the laser beams 25_{G} and 25_{B} are incident on the mixing region 43. The laser beams 25_{G} and 25_{B} travel in the +y-axis direction in the mixing region 43. The light guide region may be provided between the incidence surface 41_{G}B and the mixing region 43.

As illustrated in FIG. 4, the green laser light source 21_{G} is disposed so as to face the incidence surface 41_{GB} of the upward light guide plate 40. The green laser beam 25_{G} emitted from the green laser light source 21_{G} travels in the +y-axis direction while being reflected inside the light guide plate 40.

The laser beam 25_{G} is incident on the mixing region 43. The laser beam 25_{G} travels in the +y-axis direction in the mixing region 43.

The blue laser light source 21_{B} is disposed so as to face the incidence surface 41_{GB} of the upward light guide plate 40. The blue laser beam 25_{B} emitted from the blue laser light source 21_{B} travels in the +y-axis direction while being reflected inside the light guide plate 40.

The laser beam 25_{B} is incident on the mixing region 43. The laser beam 25_{B} travels in the +y-axis direction in the mixing region 43.

The laser beams 25_{R}, 25_{G}, and 25_{B} that have been incident on the upward light guide plate 40 from the incidence surfaces 41_{R} and 41_{G}B travel in the +y-axis direction.

The laser beams 25_{R}, 25_{G}, and 25_{B} travel in the +y-axis direction in the mixing region 43. The laser beams 25_{R}, 25_{G}, and 25_{B} undergo the total reflection repeatedly in the mixing region 43. The laser beams 25_{R}, 25_{G}, and 25_{B} are superimposed on one another in the mixing region 43.

The laser beam 25_{R}, the laser beam 25_{G}, and the laser beam 25_{B} travel in the +y-axis direction while being mixed in the mixing region 43. The longer the length of the mixing region 43 in the y-axis direction is, the more easily the three laser beams 25_{R}, 25_{G}, and 25_{B} are mixed.

It is sufficient to finish the mixing of the three laser beams 25_{R}, 25_{G}, and 25_{B} before the beams 25_{R}, 25_{G}, and 25_{B} reach the emission surface 42. That is, it is sufficient for the three laser beams 25_{R}, 25_{G}, and 25_{B} to become the laser beams 25_{W} before the laser beams 25_{R}, 25_{G}, and 25_{B} are emitted from the emission surface 42.

Thus, in the sections of the embodiment where beams after exiting from the mixing region 43 until reaching the emission surface 42 are indicated as the laser beams 25_{R}, 25_{G}, and 25_{B}, the beams can be replaced by the laser beams 25_{W}. Similarly, in the sections where beams after exiting from the mixing region 43 until reaching the emission surface 42 are indicated as the laser beams 25_{W}, the beams can be replaced by the laser beams 25_{R}, 25_{G}, and 25_{B}.

In the first embodiment, the laser beams 25_{R}, 25_{G}, and 25_{B} inside the reflection region 44 can be replaced by the laser beams 25_{W}. The laser beams 25_{W} inside the reflection region 44 can be replaced by the laser beams 25_{R}, 25_{G}, and 25_{B}.

The traveling direction of the laser beams 25_{R}, 25_{G}, and 25_{B} that have traveled in the mixing region 43 is changed in the reflection region 44. In the first embodiment, the traveling direction of the laser beams 25_{R}, 25_{G}, and 25_{B} traveling in the +y-axis direction is changed to the −y axis direction in the reflection region 44.

In a case where the laser beams 25_{R}, 25_{G}, and 25_{B} are mixed in the mixing region 43 to be the laser beams 25_{W}, the mixed laser beams 25_{W} travel in the +y-axis direction inside the mixing region 43 of the upward light guide plate 40. Note that the laser beams 25_{W} may be produced before being emitted from the emission surface 42.

The reflection surface 45 reflects the laser beams 25_{R}, 25_{G}, and 25_{B}, which travel in the +y-axis direction, thereby causing the laser beams to travel in the +z-axis direction. The reflection surface 46 reflects the laser beams 25_{R}, 25_{G}, and 25_{B}, which travel in the +z-axis direction, thereby causing the laser beams to travel in the −y axis direction.

The traveling direction of the mixed laser beams 25_{W} is changed in the reflection region 44. In FIG. 4, the mixed laser beams 25_{W} are reflected on the reflection surface 45 and turned to the +z-axis direction. The laser beams 25_{W} reflected on the reflection surface 45 are reflected on the reflection surface 46 and turned to the −y axis direction.

The reflection of the laser beams 25_{W} is, for example, the total reflection. The reflection on the reflection surfaces 45 and 46 is, for example, the total reflection.

The laser beams 25_{R}, 25_{G}, and 25_{B} whose traveling direction has been changed in the reflection region 44 are emitted from the emission surface 42.

The laser beams 25_{W} reflected on the reflection surface 46 are emitted from the emission surface 42 in the −y axis direction.

The laser beams 25_{R}, 25_{G}, and 25_{B} emitted from the emission surface 42 have been mixed and have become the laser beams 25_{W}. The laser beams 25_{W} are, for example, white light.

The laser beam 25_{W} emitted from the emission surface 42 is linear light. The laser beams 25_{W} emitted from the emission surface 42 are, for example, white linear light.

The laser beams 25_{W} emitted from the emission surface 42 reach the incidence surface 71 of the light guide plate 70. Then, the laser beams 25_{W} are incident on the light guide plate 70 from the incidence surface 71.

The laser beams 25_{W} emitted from the emission surface 42 become incident light on the light guide plate 70. That is, the laser beams 25_{W} emitted from the emission surface 42 are incident on the incidence surface 71 of the light guide plate 70.

FIG. 5 is an explanatory diagram for describing behavior of light traveling in the downward light guide plate 50.

The laser beams 26_{R}, 26_{G}, and 26_{B} that have been incident on the downward light guide plate 50 from the incidence surfaces 51_{R} and 51_{GB} travel in the −y axis direction.

As illustrated in FIG. 5, the green laser light source 22_{G} is disposed so as to face the incidence surface 51_{GB} of the downward light guide plate 50. The green laser beam 26_{G} emitted from the green laser light source 22_{G} travels in the −y axis direction while being reflected inside the light guide plate 50.

The laser beam 26_{G} is incident on the light guide region 57. The laser beam 26_{G} travels in the −y axis direction in the light guide region 57. Then, the laser beam 26_{G} is incident on the mixing region 53 from the light guide region 57. The laser beam 26_{G} travels in the −y axis direction in the mixing region 53.

The blue laser light source 22_{B} is disposed so as to face the incidence surface 51_{GB} of the downward light guide plate 50. The blue laser beam 26_{B} emitted from the blue laser light source 22_{B} travels in the −y axis direction while being reflected inside the light guide plate 50.

The laser beam 26_{B} is incident on the light guide region 57. The laser beam 26_{B} travels in the −y axis direction in the light guide region 57. Then, the laser beam 26_{B} is incident on the mixing region 53 from the light guide region 57. The laser beam 26_{B} travels in the −y axis direction in the mixing region 53.

As described above, the laser beams 26_{G} and 26_{B} are incident on the light guide region 57. The laser beams 26_{G} and 26_{B} travel in the −y axis direction in the light guide region 57. Then, the laser beams 26_{G} and 26_{B} enter the mixing region 53 from the light guide region 57. The laser beams 26_{G} and 26_{B} travel in the −y axis direction in the mixing region 53.

On the other hand, the laser beam 26_{R} is incident on the mixing region 53. The laser beam 26_{R} travels in the −y axis direction in the mixing region 53. The light guide region may be provided between the incidence surface 51_{R} and the mixing region 53.

As illustrated in FIG. 5, the red laser light source 22_{R} is disposed so as to face the incidence surface 51_{R} of the downward light guide plate 50. A red laser beam 26_{R} emitted from the red laser light source 22_{R} travels in the −y axis direction while being reflected inside the light guide plate 50.

The laser beam 26_{R} is incident on the mixing region 53. The laser beam 26_{R} travels in the −y axis direction in the mixing region 53.

The laser beams 26_{R}, 26_{G}, and 26_{B} that have been incident on the downward light guide plate 50 from the incidence surfaces 51_{R} and 51_{GB} travel in the −y axis direction.

The laser beams 26_{R}, 26_{G}, and 26_{B} travel in the −y axis direction in the mixing region 53. The laser beams 26_{R}, 26_{G}, and 26_{B} repeatedly undergo the total reflection in the mixing region 53. The laser beams 26_{R}, 26_{G}, and 26_{B} are superimposed on one another in the mixing region 53.

The laser beam 26_{R}, the laser beam 26_{G}, and the laser beam 26_{B} travel in the −y axis direction while being mixed in the mixing region 53. The longer the length of the mixing region 53 in the y-axis direction is, the more easily the three laser beams 26_{R}, 26_{G}, and 26_{B} are mixed.

It is sufficient to finish the mixing of the three laser beams 26_{R}, 26_{G}, and 26_{B} before the beams 26_{R}, 26_{G}, and 26_{B} reach the emission surface 52. That is, it is sufficient for the three laser beams 26_{R}, 26_{G}, and 26_{B} to become the laser beams 26_{W} before the laser beams 26_{R}, 26_{G}, and 26_{B} are emitted from the emission surface 52.

Thus, in the sections of the embodiment where beams after exiting from the mixing region 53 until reaching the emission surface 52 are indicated as the laser beams 26_{R}, 26_{G}, and 26_{B}, the beams can be replaced by the laser beams 26_{W}. Similarly, in the sections where beams after exiting from the mixing region 53 until reaching the emission surface 52 are indicated as the laser beams 26_{W}, the beams can be replaced by the laser beams 26_{R}, 26_{G}, and 26_{B}.

In the first embodiment, the laser beams 26_{R}, 26_{G}, and 26_{B} inside the reflection region 54 can be replaced by the laser beams 26_{W}. The laser beams 26w inside the reflection region 54 can be replaced by the laser beams 26_{R}, 26_{G}, and 26_{B}.

The traveling direction of the laser beams 26_{R}, 26_{G}, and 26_{B} that have traveled in the mixing region 53 is changed in the reflection region 54. In the first embodiment, the traveling direction of the laser beams 26_{R}, 26_{G}, and 26_{B} traveling in the −y axis direction is changed to the +y-axis direction in the reflection region 54.

In a case where the laser beams 26_{R}, 26_{G}, and 26_{B} are mixed in the mixing region 53 to be the laser beams 26_{W}, the mixed laser beams 26_{W} travel in the −y axis direction inside the mixing region 53 of the downward light guide plate 50. Note that the laser beams 26_{W} may be produced before being emitted from the emission surface 52.

The reflection surface 55 reflects the laser beams 26_{R}, 26_{G}, and 26_{B}, which travel in the −y axis direction, thereby causing the laser beams to travel in the +z-axis direction. The reflection surface 56 reflects the laser beams 25_{R}, 25_{G}, and 25₈, which travel in the +z-axis direction, thereby causing the laser beams to travel in the +y-axis direction.

The traveling direction of the mixed laser beams 26_{W} is changed in the reflection region 54. In FIG. 5, the mixed laser beams 26_{W} are reflected on the reflection surface 55 and turned to the +z-axis direction. The laser beams 26_{W} reflected on the reflection surface 55 are reflected on the reflection surface 56 and turned to the +y-axis direction.

The reflection of the laser beams 26_{W} is, for example, the total reflection. The reflection on the reflection surfaces 55 and 56 is, for example, the total reflection.

The laser beams 26_{R}, 26_{G}, and 26_{B} whose traveling direction has been changed in the reflection region 54 are emitted from the emission surface 52.

The laser beams 26_{W} reflected on the reflection surface 56 are emitted from the emission surface 52 in the +y-axis direction.

The laser beams 26_{R}, 26_{G}, and 26_{B} emitted from the emission surface 52 have been mixed and have become the laser beams 26_{W}. The laser beams 26_{W} are, for example, white light.

The laser beams 26_{W} emitted from the emission surface 52 are linear light. The laser beams 26_{W} emitted from the emission surface 52 are, for example, white linear light.

The laser beams 26_{W} emitted from the emission surface 52 reach the incidence surface 72 of the light guide plate 70. Then, the laser beams 26_{W} are incident on the light guide plate 70 from the incidence surface 72.

The laser beams 26_{W} emitted from the emission surface 52 become incident light on the light guide plate 70. That is, the laser beams 26_{W} emitted from the emission surface 52 are incident on the incidence surface 72 of the light guide plate 70.

The reflection surfaces 45, 46, 55, and 56 may be formed as mirror surfaces by mirror evaporation, for example. However, in view of efficiency of utilization of light (hereinafter referred to as light utilization efficiency), the reflection surfaces 45, 46, 55, and 56 preferably use the total reflection.

This is because the total reflection surface has a higher reflectance than that of the mirror surface, and contributes to improvement of the light utilization efficiency. In addition, the absence of a mirror evaporation process can simplify the production process of the light guide plates 40 and 50. In addition, the absence of the mirror evaporation process contributes to reduction of production costs of the light guide plates 40 and 503.

The laser beams 25_{W} are incident on the light guide plate 70 from the incidence surface 71 facing in the +y-axis direction. The laser beams 26_{W} are incident on the light guide plate 70 from the incidence surface 72 facing in the −y axis direction.

The laser beams 25_{W} travel in the −y axis direction inside the light guide plate 70 while being repeatedly reflected between the front surface (emission surface 73) and the back surface. The laser beams 26_{W} travel in the +y-axis direction inside the light guide plate 70 while being repeatedly reflected between the front surface (emission surface 73) and the back surface.

However, laser beams 25_{W} and 26_{W} that do not satisfy the total reflection condition any more at the interface between the front surface (emission surface 73) of the light guide plate 70 and the air layer, are emitted from the front surface (emission surface 73) of the light guide plate 70 to the outside. Laser beams 25_{W} and 26_{W} that do not satisfy the total reflection condition any more in the uneven shape of the back surface of the light guide plate 70, are emitted from the back surface of the light guide plate 70 to the outside.

Laser beams 25_{W} and 26_{W} emitted from the back surface are caused to return to the inside of the light guide plate 70 again by the reflection sheet 60.

The optical sheet 80 is disposed on the side of the light guide plate 70 in the +z-axis direction. The front surface (emission surface 73) of the light guide plate 70 faces the back surface of the optical sheet 80.

Laser beams 25_{W} and 26_{W} emitted from the front surface (emission surface 73) of the light guide plate 70 to the outside irradiate the back surface of the optical sheet 80. The laser beams 25_{W} and 26_{W} irradiating the back surface of the optical sheet 80 are the planar light having a rectangular shape which is substantially the same as the shape of the front surface of the light guide plate 70.

The optical sheet 80 reduces minute unevenness of light intensity and the like of laser beams 25_{W} and 26_{W} emitted from the front surface (emission surface 73) of the light guide plate 70 to the outside.

In this manner, when the laser beams 25_{W} and 26_{W} that have changed to the planar light are emitted from the optical sheet 80 toward the liquid crystal display element 90, the laser beams 25_{W} and 26_{W} illuminate the entire display surface of the liquid crystal display element 90 with increased uniformity.

### <Heat Generation by Laser Light Sources 21 and 22>

As the laser light sources 21 and 22, semiconductor lasers are used, for example. The semiconductor lasers generate heat when emitting light. The heat is proportional to the amount of current applied to the semiconductor lasers. Thus, as the laser light sources 21 and 22 operate with high luminance with increased laser power, the laser light sources 21 and 22 generate a larger amount of heat so that the temperature of the laser light sources 21 and 22 increases.

Characteristics of a semiconductor laser are susceptible to the influence of temperature. When the temperature of the semiconductor laser rises, variation in the wavelength of the semiconductor laser, decrease in the power or the like is caused. In the worst case, destruction of the semiconductor laser itself or the like is caused.

In particular, the red laser light sources 21_{R} and 22_{R} are susceptible to the influence of heat, and if the red laser light sources 21_{R} and 22_{R} are continuously used at high temperatures, degradation of the laser light sources 21_{R} and 22_{R} is accelerated and their lifetimes are shortened.

In recent surface light source devices, there have been demands for increase in luminance and uniformization of light intensity distribution. Thus, the surface light source devices are used while the amount of current used for light sources is increased, for example. Alternatively, a structure in which a density of light sources is increased by increasing the number of light sources has been employed.

These methods, however, increase the amount of heat generated by light sources. In particular, adjacent light sources heat each other.

Thus, it is possible that heat generated by the green laser light sources 21_{G} and 22_{G} or the blue laser light sources 21_{B} and 22_{B} affects increase in temperature of the red laser light sources 21_{R} and 22_{R}.

As described above, the configuration in which the laser light sources 21_{R} and 22_{R} are disposed in the region 48 and the laser light sources 21_{G}, 21_{B}, 22_{G}, and 22_{B} are disposed in the region 58 can reduce the influence of heat generated by the green laser light sources 21_{G} and 22_{G} or the blue laser light sources 21_{B} and 22_{B} on increase in temperature in the red laser light sources 21_{R} and 22_{R}.

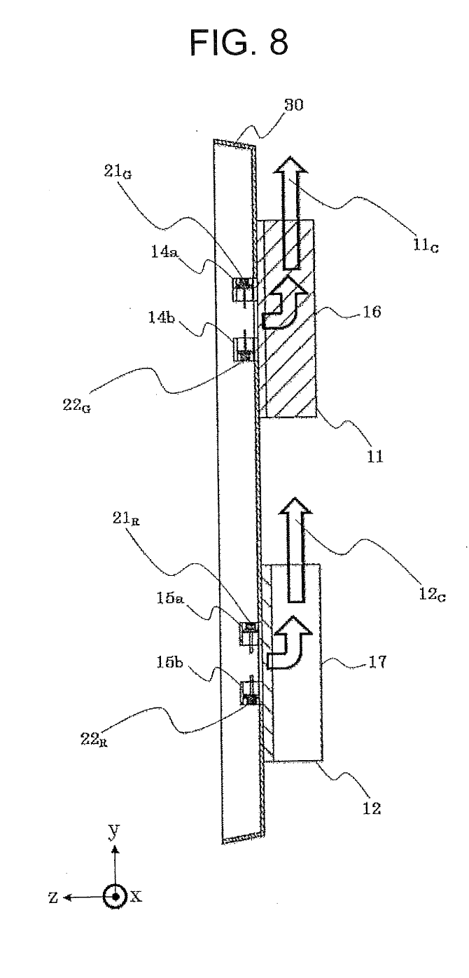

FIG. 8 is an explanatory diagram for describing heat transfer of the laser light sources 21 and 22.

To facilitate description, FIG. 8 shows only the casing 30, the heat dissipators 11 and 12, and the laser light sources 21_{G}, 22_{G}, 21_{R}, and 22_{R} and omits other components.

The red laser light sources 21_{R} and 22_{R} are attached to the heat dissipator 12.

Heat generated by the red laser light sources 21_{R} and 22_{R} is transferred to the holders 15a and 15b of the heat dissipator 12. The holders 15a and 15b of the heat dissipator 12 are in contact with outer walls of the red laser light sources 21_{R} and 22_{R}. The outer walls of the laser light sources 21_{R} and 22_{R} are cases of the laser light sources 21_{R} and 22_{R}.

The heat transferred to the holders 15a and 15b is transferred to the heat dissipating fins provided in the heat dissipation portion 17 and is dissipated to the air therefrom.

Heat released to the region 48 is transferred to the heat dissipation portion 17, and is dissipated to the air from the heat dissipating fins.

Released warm air 12_{C} rises in the +y-axis direction.

At this time, heat of the holders 15a and 15b is also transferred to the casing 30. However, by sandwiching a material having a high thermal resistance between contact surfaces of the heat dissipator 12 and the casing 30, for example, the amount of heat transferred to the casing 30 can be reduced. As the material having a high thermal resistance, a resin material or a rubber material, for example, can be used. Instead of the material having a high thermal resistance, an air layer can be provided.

Alternatively, by making the heat dissipation portion 17 with a material having a small thermal resistance, for example, it is possible to allow heat to be easily transferred to the heat dissipation portion 17 and to thereby reduce the amount of heat transferred to the casing 30.

In this manner, the heat dissipator 12 releases heat to the air. The air 12_{C} warmed by the heat from the heat dissipator 12 rises in the +y-axis direction. The warm air 12_{C} rises to come into contact with and heat the heat dissipator 11 disposed in an upper part. This is because the warm air 12_{C} dissipated in the air is lighter than the ambient air and thus rises.

For this reason, fresh air flows into the heat dissipation portion 17 of the heat dissipator 12 from the −y axis direction or from the −z axis direction. The “fresh air” is air that has not received heat from the heat dissipating fins or heat from the casing 30. That is, the “fresh air” is air that is not heated. The temperature of the “fresh air” is lower than the temperature of the air 12_{C}.

The amount of heat transferred from the front surface side (+z-axis direction) of the heat dissipator 12 to the air increases as the difference between the surface temperature of the heat dissipator 12 and the temperature of the air increases. That is, as the temperature of the air flowing into the heat dissipator 12 decreases, efficiency of releasing heat from the heat dissipator 12 increases.

The green laser light sources 21_{G} and 22_{G} and the blue laser light sources 21_{B} and 22_{B} (not shown) are attached to the heat dissipator 11.

Similarly, heat generated by the laser light sources 21_{G}, 22_{G}, 21_{B}, and 22_{B} is transferred to the holders 14a and 14b of the heat dissipator 11. The holders 14a and 14b of the heat dissipator 11 are in contact with outer walls of the laser light sources 21_{G}, 22_{G}, 21_{B}, and 22_{B}. The outer walls of the laser light sources 21_{G}, 22_{G}, 21_{B}, and 22_{B} are cases of the laser light sources 21_{G}, 22_{G}, 21_{B}, and 22_{B}.

The heat transferred to the holders 14a and 14b is transferred to the heat dissipating fins provided in the heat dissipation portion 16 and is released to the air therefrom.

Heat released to the region 58 is transferred to the heat dissipation portion 16, and is dissipated to the air from the heat dissipating fins.

Released warm air 11c rises in the +y-axis direction.

At this time, heat of the holders 14a and 14b is also transferred to the casing 30. However, by sandwiching a material having a high thermal resistance between contact surfaces of the heat dissipator 11 and the casing 30, for example, the amount of heat transferred to the casing 30 can be reduced. As the material having a high thermal resistance, a resin material or a rubber material, for example, can be used. Instead of the material having a high thermal resistance, an air layer can be provided.

Alternatively, by making the heat dissipation portion 16 with a material having a small thermal resistance, for example, it is possible to allow heat to be easily transferred to the heat dissipation portion 16 and to thereby reduce the amount of heat transferred to the casing 30.

In this manner, the heat dissipator 11 releases heat to the air. The air 11c warmed by heat from the heat dissipator 11 does not heat the heat dissipator 12 disposed ahead of the heat dissipator 11 in the −y axis direction. That is, the red laser light sources 21_{R} and 22_{R} do not easily receive heat generated by the other laser light sources 21_{G}, 21_{B}, 22_{G}, and 22_{B.}

In the liquid crystal display device 100 according to the first embodiment, the heat dissipator 12 for the red laser light sources 21_{R} and 22_{R} is separated from the heat dissipator 11 for the laser light sources 21_{G}, 21_{B}, 22_{G}, and 22_{B} of the other colors. In the liquid crystal display device 100, the heat dissipator 12 is disposed in a lower portion of the liquid crystal display device 100 than the heat dissipator 11.

In this manner, the red laser light sources 21_{R} and 22_{R} are not easily affected by heat generated by the laser light sources 21_{G}, 21_{B}, 22_{G}, and 22_{B} of the other colors. In addition, the fresh air can be used for cooling the red laser light sources 21_{R} and 22_{R}.

The surface light source device 100 includes the laser light sources 21 and 22, the first light guide elements 40 and 50, and the second light guide element 70.

The laser light sources 21 and 22 emit the laser beams.

The first light guide elements 40 and 50 mix the plurality of laser beams 25 and 26 emitted from the laser light sources 21 and 22 and convert the plurality of laser beams to the linear light.

The second light guide element 70 receives the linear light and converts the linear light to the planar light.

The laser light sources 21 and 22 are disposed in the regions 48 and 58 separated by the first light guide elements 40 and 50.

The surface light source device 100 dissipates heat released from the laser light sources 21 and 22 into the regions 48 and 58.

The heat dissipators 11 and 12 dissipate the heat released from the laser light sources 21 and 22 into the regions 48 and 58.

### FIRST MODIFIED EXAMPLE

FIG. 9 is a view illustrating an arrangement of an upward light guide plate 40 and laser light sources 21_{R}, 21_{G}, and 21_{B} used in a surface light source device 110 according to a first modified example.

In the first modified example, only the upward light guide plate 40 is used. That is, the downward light guide plate 50 is not used.

In the case of using only the upward light guide plate 40 as well, the laser light source 21_{R} is disposed ahead of the laser light sources 21_{G} and 21_{B} in the −y axis direction. Thus, the laser light source 21_{R} is not easily affected by heat generated by the laser light sources 21_{G} and 21_{B}.

Moreover, between the laser light source 21_{R} and the laser light sources 21_{G} and 21_{B}, a light guide region 47 is disposed. Thus, the light guide region 47 prevents the heat generated by the laser light sources 21_{G} and 21_{B} from being transferred to the laser light source 21_{R}. Similarly, the light guide region 47 prevents heat generated by the laser light source 21_{R} from being transferred to the laser light sources 21_{G} and 21_{B}.

In a case of using only the downward light guide plate 50 as well, similar effect can be obtained.

### SECOND MODIFIED EXAMPLE

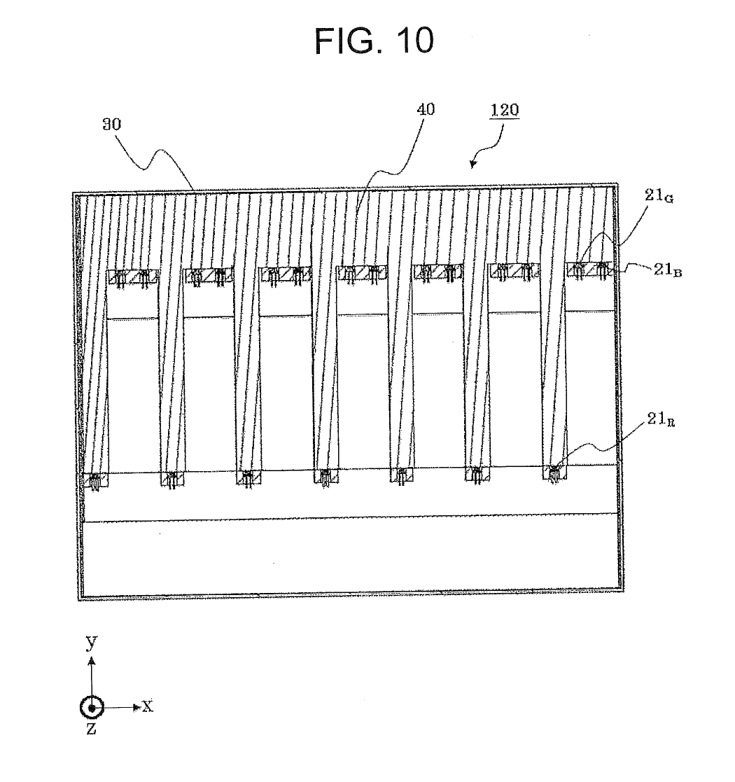

FIG. 10 is a view illustrating an arrangement of an upward light guide plate 40 and laser light sources 21_{R}, 21_{G}, and 21_{B} used in a surface light source device 120 according to a second modified example. In the second modified example, a plurality of light guide plates 40 adjacent to each other in the x-axis direction are united.

In the second modified example, only the upward light guide plate 40 is used, in a manner similar to the first modified example. That is, the downward light guide plate 50 is not used.

In this manner, no boundary is provided between adjacent light guide plates 40. Accordingly, the optical loss generated at the boundary between the light guide plates 40 can be reduced.

In a downward light guide plate 50 as well, a plurality of light guide plates 50 adjacent to each other in the x-axis direction can be united. Then, effect similar to those of the light guide plate 40 can be obtained.

Moreover, instead of the configuration illustrated in FIG. 3, the united light guide plate 40 and the united light guide plate 50 can be used.

### THIRD MODIFIED EXAMPLE

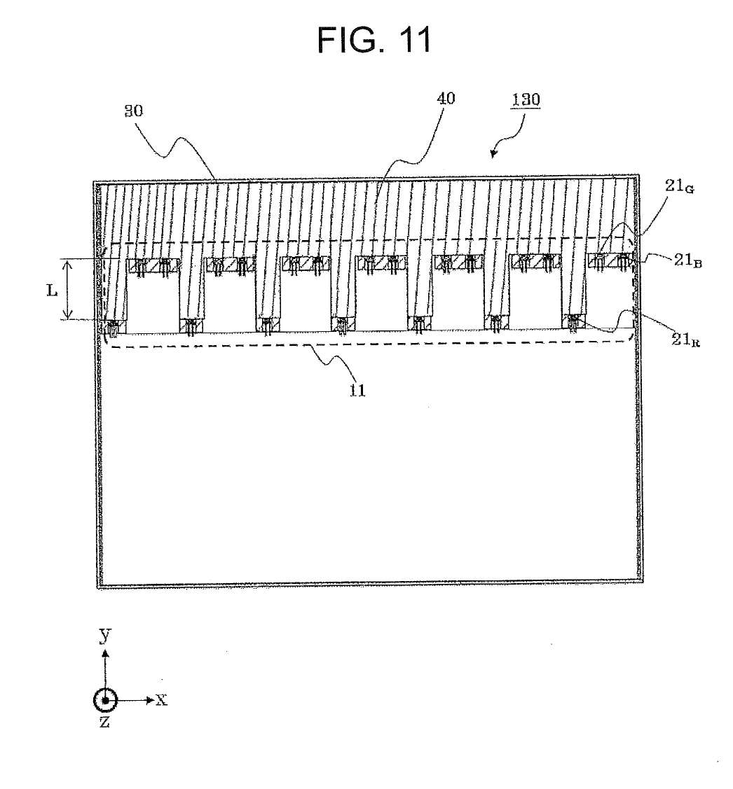

FIG. 11 is a view illustrating an arrangement of an upward light guide plate 40, laser light sources 21_{R}, 21_{G}, and 21_{B}, and a heat dissipator 11 used in a surface light source device 130 according to a third modified example.

In FIG. 11, a broken line indicates the heat dissipator 11.

In the third modified example, the red laser light source 21_{R} is separated from the laser light sources 21_{G} and 21_{B} of the other colors in the vertical direction (y-axis direction), and the laser light sources 21_{R}, 21_{G}, and 21_{B} are attached to the same heat dissipator 11.

That is, in the third modified example, the red laser light source 21_{R} and the laser light sources 21_{G} and 21_{B} of the other colors are attached to the same heat dissipator 11. The red laser light source 21_{R} is separated from the laser light sources 21_{G} and 21_{B} of the other colors in the vertical direction (y-axis direction).

In the surface light source device 130, the red laser light source 21_{R} is separated from the laser light sources 21_{G} and 21_{B} of the other colors and disposed on the lower side of the laser light sources 21_{G} and 21_{B}. A separation distance L is a distance between the red laser light source 21_{R} and the laser light sources 21_{G} and 21_{B} of the other colors in the y-axis direction. That is, the red laser light source 21_{R} is separated from the laser light sources 21_{G} and 21_{B} of the other colors by the distance L and disposed on the lower side of the laser light sources 21_{G} and 21_{B}.

By adjusting the separation distance L, it becomes difficult for the laser light source 21_{R} to be affected by heat generated by the laser light sources 21_{G} and 21_{B}. In addition, the single heat dissipator 11 can dissipate heat generated by the laser light sources 21_{R}, 21_{G}, and 21_{B}.

In this manner, the configuration of the surface light source device 130 can be simplified.

In a manner similar to the second modified example, the third modified example shows the example using the united light guide plate 40. In the third modified example, a separation type light guide plate 40 as illustrated in FIG. 3 can be used.

### FOURTH MODIFIED EXAMPLE

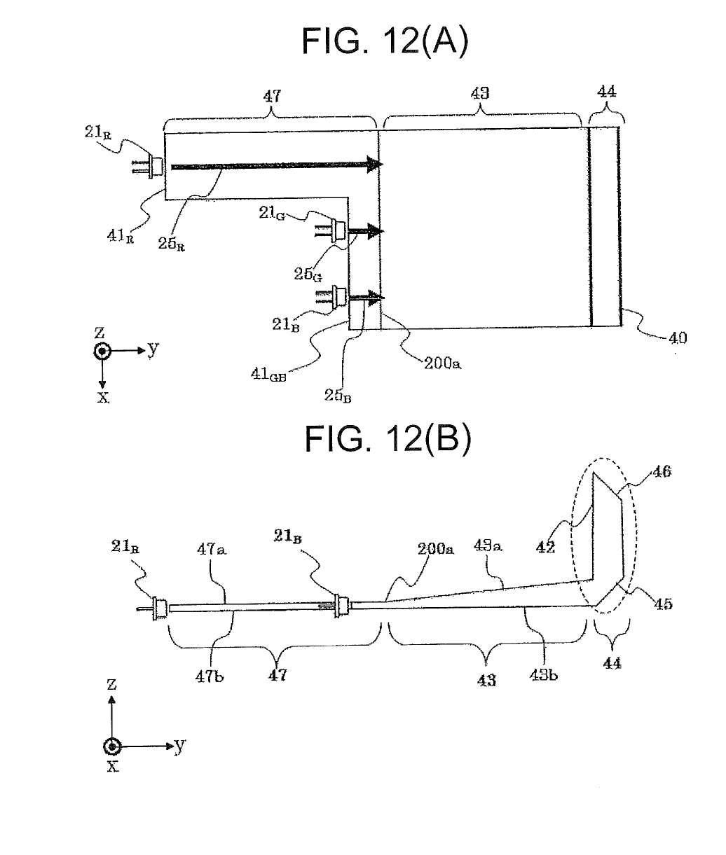

FIG. 12(A) is a top view illustrating an arrangement of an upward light guide plate 40 and laser light sources 21_{R}, 21_{G}, and 21_{B} used in a surface light source device 140 according to a fourth modified example. FIG. 12(B) is a side view illustrating an arrangement of the upward light guide plate 40 and the laser light sources 21_{R}, 21_{G}, and 21_{B} used in the surface light source device 140 according to the fourth modified example.

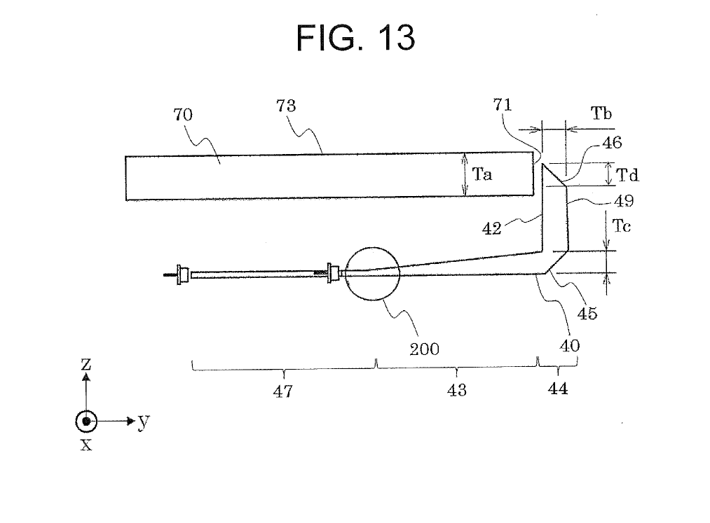

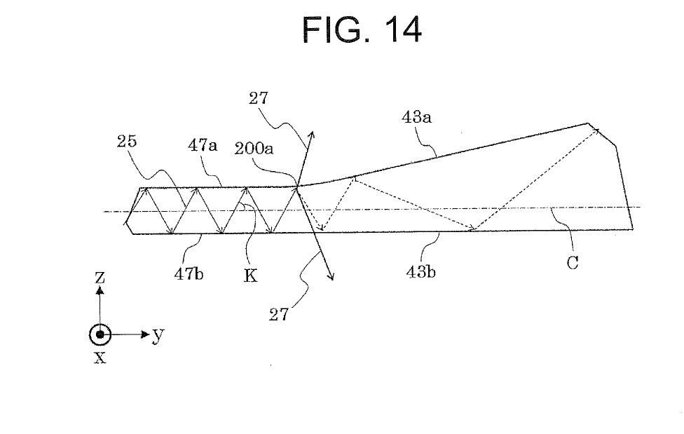

FIG. 13 is an explanatory diagram for describing thickness conditions of the upward light guide plate 40. FIG. 14 is an explanatory diagram for describing behavior of a beam traveling inside a connection portion 200 of the upward light guide plate 40.

In the fourth modified example, the light guide plate 40 is described as an example. A light guide plate 50 is similar to the light guide plate 40, and thus, explanation thereof will be omitted.

As illustrated in FIGS. 12(A) and 12(B), a red laser light source 21_{R} is disposed on an incidence surface 41_{R} of the upward light guide plate 40. A green laser light source 21_{G} and a blue laser light source 21_{B} are disposed on an incidence surface 41_{G}B. The upward light guide plate 40 is divided into three regions of a light guide region 47, a mixing region 43, and a reflection region 44.

In the configuration illustrated in FIG. 12, laser beams 25_{G} and 25_{B} incident on the light guide plate 40 from the incidence surface 41_{GB} are once incident on the light guide region 47.

As will be described later, these three regions 43, 44, and 47 have different thicknesses.

Explanation will now be given using the side view of FIG. 12(B). Note that the front surface is a surface facing in the +z-axis direction, and the back surface is a surface facing in the −z axis direction.

The light guide region 47 has a uniform thickness, for example. The light guide region 47 has a front surface 47a and a back surface 47b. These two plane surfaces 47a and 47b are first plane surfaces. The front surface 47a is parallel to the back surface 47b, for example. Thus, the light incidence surfaces 41_{R} and 41_{GB} have the same thickness in the z-axis direction.

The mixing region 43 is disposed ahead of the light guide region 47 in the +y-axis direction. The mixing region 43 is optically disposed between the light guide region 47 and the reflection region 44.

The mixing region 43 has a front surface 43a and a back surface 43b. These two plane surfaces 43a and 43b are second plane surfaces. The back surface 43b of the mixing region 43 is flush with the back surface 47b of the light guide region 47.

On the other hand, the front surface 43a is tilted relative to the back surface 43b so that the thickness increases toward the reflection region 44. That is, the front surface 43a is tilted relative to the back surface 43b so that the thickness increases in the +y-axis direction. The front surface 43a is tilted relative to the back surface 43b so that an optical path is widened toward the direction in which laser beams 25 travel. When the surface is tilted so as to widen the optical path, the tilted surface is seen from the direction in which the laser beams 25 travel.

A connection line 200a is provided on a connection portion 200 between the light guide region 47 and the mixing region 43 on the side of the front surfaces 43a and 47a. The connection line 200a is a part connecting the front surface 47a of the light guide region 47 and the front surface 43a of the mixing region 43.

The reflection region 44 has two reflection surfaces 45 and 46. The reflection surfaces 45 and 46 reflect laser beams 25_{W} which have been incident on the reflection region 44. The laser beams 25_{W} reflected on the reflection surface 46 are emitted toward the incidence surface 71 of the light guide plate 70.

As illustrated in FIG. 13, a dimension Ta represents a thickness of the light guide plate 70. That is, the dimension Ta represents a dimension in the z-axis direction of the incidence surface 71. In a case where the front surface (emission surface 73) and the back surface of the light guide plate 70 are not parallel to each other, the dimension Ta represents the dimension in the z-axis direction of the incidence surface 71. In the case where the front surface (emission surface 73) and the back surface of the light guide plate 70 are not parallel to each other, the dimension Ta represents a dimension of a distance between the front surface (emission surface 73) and the back surface in the incidence surface 71.

A dimension Tb is a thickness of the reflection region 44. That is, the dimension Tb is a dimension in the y-axis direction of the reflection region 44. The dimension Tb is a dimension in the y-axis direction of a light flux of laser beams 25_{W} incident on the reflection surface 46. The dimension Tb is a dimension of the light flux of the laser beams 25_{W} incident on the reflection surface 46, which is in a direction corresponding to the dimension Ta.

In FIG. 13, the surface of the reflection region 44 which faces in the −y axis direction (emission surface 42) is parallel to a surface 49 of the reflection region 44 which faces in the +y-axis direction. In FIG. 13, as an example, the surface of the reflection region 44 which faces in the −y axis direction is identical to the emission surface 42.

A dimension Tc is a dimension in the z-axis direction of a connection portion between the mixing region 43 and the reflection region 44. The dimension Tc is a dimension in the z-axis direction of a light flux of laser beams 25_{W} incident on the reflection surface 45. The dimension Tc is a dimension of the light flux of the laser beams 25_{W} incident on the reflection surface 45, which is in a direction corresponding to the dimension Ta.

The dimension Ta of the light guide plate 70 and the dimensions Tb and Tc of the upward light guide plate 40 satisfy a relationship of Ta>Tb>Tc.

Moreover, a dimension in the z-axis direction of a light flux of the laser beams 25_{W} reflected on the reflection surface 46 in the −y axis direction is a dimension Td. The dimension Td is a dimension of the light flux of the laser beams 25_{W} reflected in the −y axis direction on the reflection surface 46, which is in a direction corresponding to the dimension Ta. The dimension Td is a dimension of a light flux of laser beams 25_{W} when the laser beams 25W are emitted from the emission surface 42. The dimension Td of the light flux of the laser beams 25_{W} satisfies a relationship of Ta>Td>Tc.

Next, the above dimensions Ta, Tb, Tc, and Td will be described.

When viewed in the y-z plane, a light flux of laser beams 25_{W} incident on the reflection region 44 from the mixing region 43 is converted to a state close to a parallel light flux in the mixing region 43 in the z-axis direction.

The “parallel light flux” described below means that light beams are parallel when viewed in the y-z plane.

However, considering that the light flux of the laser beams 25_{W} is a light flux that slightly expands, a dimension in the z-axis direction of the reflection surface 45 is set to be larger than the dimension Tc.

In this manner, large part of the laser beams 25_{W} incident on the reflection region 44 from the mixing region 43 can be reflected on the reflection surface 45. Accordingly, a decrease of light efficiency of the laser beams 25_{W} can be reduced. That is, since beams are parallel when viewed in the y-z plane, the laser beams 25_{W} incident on the reflection region 44 readily satisfy the total reflection condition on the reflection surface 45.

Thus, a dimension in the y-axis direction of a light flux of laser beams 25_{W} reflected on the reflection surface 45 is larger than the dimension Tc.

The dimension Tb of the reflection region 44 is set to be larger than the dimension in the y-axis direction of the light flux of the laser beams 25_{W} reflected on the reflection surface 45. This setting is made so as not to block an optical path of the laser beams 25_{W} reflected on the reflection surface 45.

For this reason, as illustrated in FIG. 13, for example, in a case where the reflection region 44 has a plate shape, the dimension Tb in the thickness direction (y-axis direction) of the reflection region 44 is larger than the dimension Tc of the connection portion between the mixing region 43 and the reflection region 44.

In a case where two plane surfaces of the plate-shaped reflection region 44 are parallel, a distance between the two plane surfaces is the dimension Tb. In FIG. 13, the two plane surfaces of the reflection region 44 are parallel to the z-x plane.

In a case where the two plane surfaces of the plate-shaped reflection region 44 are tilted, the two plane surfaces of the reflection region 44 are tilted so that the distance between the two plane surfaces increases in the +z-axis direction. That is, the two plane surfaces of the reflection region 44 are tilted so that the optical path is widened toward the direction in which laser beams 25_{W} travel.

In this case, the dimension Tb is a dimension of the maximum distance between the two plane surfaces of the reflection region 44. Since the two plane surfaces of the reflection region 44 are tilted so that the optical path is widened, the dimension Tb is optically a dimension of an end portion of the reflection region 44 on the side of the incidence surface 71.

From the foregoing explanation, the dimension Td in the z-axis direction of the light flux of the laser beams 25_{W} reflected on the reflection surface 46 is also larger than the dimension Tc.

This condition is also satisfied in a case where the reflection region 44 has a triangular prism shape, for example.

This is because the dimension in the z-axis direction of the reflection surface 45 is set to be larger than the dimension Tc, and in addition, the light flux of laser beams 25_{W} in the reflection region 44 is the parallel light flux or expands from the parallel light flux.

Moreover, the light flux of the laser beams 25_{W} reflected on the reflection surface 46 in the −y axis direction is the parallel light flux or expands from the parallel light flux. Thus, the dimension Ta is set to be larger than the dimension Td. The dimension Ta is set to be larger than the dimension Tb.

In this manner, it is possible to reduce a decrease in the light utilization efficiency of laser beams 25_{W} incident on the light guide plate 70 from the reflection region 44.

Behavior of light inside the light guide plate 40 will now be described.

Explanation will be given using a cross-sectional view of the connection portion 200 in FIG. 14. In FIG. 14, the laser beams 25_{R}, 25_{G}, and 25_{B} are collectively shown as laser beams 25. An axis C is an axis parallel to the y-axis.

The red laser beam 25_{R} that has entered from the incidence surface 41_{R} travels inside the light guide region 47 to the connection portion 200 while repeatedly undergoing total reflection.

Similarly, the green laser beam 25_{G} and the blue laser beam 25_{B} that have entered from the incidence surface 41_{GB} also travel inside the light guide region 47 to the connection portion 200 while repeatedly undergoing total reflection.

The laser beams 25_{R}, 25_{G}, and 25_{B} incident on the light guide plate 40 from the incidence surfaces 41_{R} and 41_{G}B. For example, the incidence surfaces 41_{R} and 41_{GB} have the same thickness.

An angle K of the beams 25 traveling while being repeatedly reflected between the two parallel plane surfaces 47a and 47b relative to the traveling direction is kept. That is, assuming that the two plane surfaces 47a and 47b are parallel to the x-y plane, the angle K of the laser beams 25_{R}, 25_{G}, and 25_{B} relative to the y-axis on the y-z plane that have entered from the incidence surfaces 41_{R} and 41_{G}B does not change and is kept even when the laser beams 25_{R}, 25_{G}, and 25_{B} reach the connection portion 200.

That is, on the y-z plane, the angle K of the laser beams 25_{R}, 25_{G}, and 25_{B} relative to the y-axis is kept in the light guide region 47. The y-axis is parallel to the traveling direction of the laser beams 25_{R}, 25_{G}, and 25_{B}. The y-z plane is a plane perpendicular to the plane surfaces 47a and 47b, and parallel to the y-axis.

Thus, even in a case where a distance from the incidence surface 41_{R} to the mixing region 43 is different from a distance from the incidence surface 41_{GB} to the mixing region 43, the angles K at which the laser beams 25_{R}, 25_{G}, and 25_{B} are incident on the mixing region 43 can be made the same. By making the angles K of the laser beams 25_{R}, 25_{G}, and 25_{B} when the laser beams 25_{R}, 25_{G}, and 25_{B} are incident on the mixing region 43 the same, conditions of the laser beams 25_{R}, 25_{G}, and 25_{B} when the laser beams 25_{R}, 25_{G}, and 25_{B} are incident on the mixing region 43 can be made the same. Thereby, the laser beams 25_{R}, 25_{G}, and 25_{B} can be easily mixed.

In the foregoing explanation, the radiation angles (angles of divergence) of the laser beams 25_{R}, 25_{G}, and 25_{B} when the laser beams 25_{R}, 25_{G}, and 25_{B} are emitted from the laser light sources 21_{R}, 21_{G}, and 21_{B} are equal. In a case where the radiation angle varies among the laser light sources 21_{R}, 21_{G}, and 21_{B}, however, the surface of the light guide region 47 is tilted in a manner similar to the mixing region 43 and thereby the angle K when the beams are incident on the mixing region 43 can be made the same.

In this case, different light guide regions 47 are provided for the laser light sources 21_{R}, 21_{G}, and 21_{B}.

In the mixing region 43 illustrated in FIG. 14, the front surface 43a is tilted relative to the y-axis. The front surface 43a is tilted relative to the back surface 43b so that the optical path enlarges as the laser beams 25_{R}, 25_{G}, and 25_{B} travel. In FIG. 14, the back surface 43b is parallel to the y-axis.

In the mixing region 43 illustrated in FIG. 14, the front surface 43a is tilted relative to the x-y plane. In FIG. 14, the back surface 43b is parallel to the x-y plane.

The angle K of the laser beams 25_{R}, 25_{G}, and 25_{B} relative to the y-axis decreases on the y-z plane each time the laser beams 25_{R}, 25_{G}, and 25_{B} are reflected on the tilted front surface 43a. That is, the laser beams 25_{R}, 25_{G}, and 25_{B} gradually become the parallel light flux relative to the y-axis each time the laser beams 25_{R}, 25_{G}, and 25_{B} are reflected on the titled front surface 43a.

The angle K of the laser beams 25_{R}, 25_{G}, and 25_{B} relative to the x-y plane decreases each time the laser beams 25_{R}, 25_{G}, and 25_{B} are reflected on the tilted front surface 43a. That is, the laser beams 25_{R}, 25_{G}, and 25_{B} gradually become the parallel light flux relative to the x-y plane each time the laser beams 25_{R}, 25_{G}, and 25_{B} are reflected on the tilted front surface 43a. The angle K of laser beams 25_{R}, 25_{G}, and 25_{B} relative to the back surface 43b decreases each time the laser beams 25_{R}, 25_{G}, and 25_{B} are reflected on the tilted front surface 43a.

The reflection surfaces 45 and 46 are preferably the total reflection surfaces as described above. Thus, the incident angle of the laser beams 25_{R}, 25_{G}, and 25_{B} incident on the reflection surfaces 45 and 46 needs to be within a range satisfying the total reflection condition.

The total reflection condition can be easily satisfied by causing the laser beams 25_{R}, 25_{G}, and 25_{B} to approach the parallel light flux in the mixing region 43. In this manner, the efficiency of utilization of light in the light guide plate 40 can be increased.

In the manner described above, even in a case where the plurality of laser light sources 21 are disposed in a position away from each other, by making the two surfaces 47a and 47b of the light guide plate 40 parallel to each other, the angle K of the laser beams 25 relative to the traveling direction can be kept. The surfaces 47a and 47b are reflection surfaces for guiding the laser beams 25. In this manner, the same process can be performed as in the case where a plurality of laser beams 25 are caused to enter the same incidence surface 41. Then, the plurality of laser beams 25 can be easily mixed.

For example, in a manner similar to the front surface 43a of the mixing region 43, the back surface 43b can also be tilted relative to the y-axis. That is, the back surface 43b can also be tilted relative to the x-y plane. When viewed from the +x-axis direction, the back surface 43b can be tilted clockwise relative to the x-y plane. That is, the back surface 43b can be tilted relative to the x-y plane so that the optical path is widened. In this manner, the laser beams from the laser light sources 21 can approach the parallel light flux.

However, in a case where each of the light guide plates 40 and 50 is formed with a metal mold, for example, the connection line 200a is formed with a curved surface which is not optically designed in general. Moreover, in a case where the light guide plates 40 and 50 are processed by cutting, the connection line 200a is also formed with a curved surface which is not optically designed in general.

At such a curved surface, the optical loss occurs because of transmission or reflection of light beams 27 which is not intended at the time of optical design. The light beams 27 travel to the outside of the light guide plate 40. Then, the light beams 27 are not used as light for illuminating the liquid crystal display element 90.

Thus, as illustrated in FIG. 12(B), only one surface of the mixing region 43 is tilted so that the optical loss in the connection portion 200 can be reduced.

In the case where the light guide plate 40 is processed by metal molding, as illustrated in FIG. 12(B), the back surface 43b of the mixing region 43 is made flush with the back surface 47b of the light guide region 47 so that the back surfaces 43b and 47b can be formed by divided surfaces of the metal mold.

In taking a molded product out of the metal mold, the metal mold is generally divided into two or three. This divided surface of the metal mold is also referred to as a “parting surface.”

In this manner, the back surface 43b of the mixing region 43 is made flush with the back surface 47b of the light guide region 47 so that the metal mold can be easily formed. In addition, the lifetime of the metal mold can be prolonged.

In the foregoing embodiment, terms indicating a positional relationship between components, such as “parallel” and “perpendicular,” or a shape of a component are sometimes used. These terms are intended to include a range in which tolerance in production, variation in assembly and so on are taken into consideration. Thus, in description indicating a positional relationship between components or a shape of a component in the claims, this description includes a range in which tolerance in production, variation in assembly and so on are taken into consideration.

Although the foregoing description is directed to the embodiment of the present invention, the invention is not limited to the embodiment.

The following description will be given as appendixes.

### <Appendix 1>

A surface light source device including:
a red laser light source configured to emit red laser light;
a blue laser light source configured to emit blue laser light;
a green laser light source configured to emit green laser light;
a first light guide plate that mixes the red laser light, the green laser light, and the blue laser light to convert the red laser light, the green laser light, and the blue laser light to linear light, and
a second light guide plate that receives the linear light and converts the linear light to planar light,
wherein, when a direction in which warmed air rises is upward, the green laser light source and the blue laser light source are disposed above the red laser light source.

### <Appendix 2>

A liquid crystal display device includes:
the surface light source device described in Appendix 1;and
a liquid crystal display element that receives the planar light and produces image light.

### <Appendix 3>

A surface light source device includes:
a plurality of laser light sources configured to emit a plurality of laser light beams;
a plate-shaped first light guide plate that mixes the plurality of laser light beams emitted from the plurality of laser light sources to convert the plurality of laser light beams to linear light; and
a plate-shaped second light guide plate that receives the linear light and converts the linear light to planar light,
wherein the first light guide plate includes a light guide region in which the plurality of laser light beams are guided and a mixing region in which the plurality of laser beams are mixed,
a part of the light guide region from which light is emitted is connected to a part of the mixing region on which light is incident,
two plane surfaces of the plate-shaped light guide region are first plane surfaces,
two plane surfaces of the plate-shaped mixing region are second plane surfaces and are tilted so that an optical path is widened toward a direction in which the plurality of laser light beams travel, and
one of the first plane surfaces is flush with one of the second plane surfaces.

### <Appendix 4>

The surface light source device described in Appendix 3, wherein the two first plane surfaces are parallel to each other.

### <Appendix 5>

The surface light source device described in Appendix 3 or 4, wherein:
the first light guide plate includes a plate-shaped reflection region having a reflection surface on which light emitted from the mixing region is reflected,
a part of the mixing region from which light is emitted is connected to a part of the reflection region on which light is incident,
light emitted from the reflection region is incident on the second light guide plate from an incidence surface provided at a side surface of the plate shape of the second light guide plate, and
when a thickness of the part of the plate shape of the mixing region from which light is emitted is a first dimension, a thickness of the plate shape of the reflection region is a second dimension, and a dimension of the incidence surface of the second light guide plate which corresponds to a thickness of the plate shape is a third dimension,
the second dimension is larger than the first dimension and smaller than the third dimension.

### <Appendix 6>

In the surface light source device described in Appendix 3 or 4, wherein:
the first light guide plate includes a reflection region having a reflection surface on which light emitted from the mixing region is reflected,
a part of the mixing region from which light is emitted is connected to a part of the reflection region on which light is incident,
light emitted from the reflection region is incident on the second light guide plate from an incidence surface provided at a side surface of the plate shape of the second light guide plate, and
when a thickness of the plate shape of the part of the mixing region from which light is emitted is a first dimension, a dimension of the incidence surface of the second light guide plate which corresponds to a thickness of the plate shape is a third dimension, and a dimension of a light flux emitted from the reflection region which is in a direction of the third dimension is a fourth dimension,
the fourth dimension is larger than the first dimension and smaller than the third dimension.

### <Appendix 7>

The surface light source device described in any one of Appendixes 3 to 6, wherein:
the plurality of laser light sources include a red laser light source configured to emit red laser light, a green laser light source configured to emit green laser light, and a blue laser light source configured to emit blue laser light,
each of the plurality of laser light sources is disposed in a first region or a second region separated by the first light guide plate,
the red laser light source is disposed in the first region, and
the green laser light source and the blue laser light source are disposed in the second region.

### <Appendix 8>

The surface light source device described in any one of Appendixes 3 to 6, wherein:
the plurality of laser light sources include a red laser light source configured to emit red laser light, a green laser light source configured to emit green laser light, and a blue laser light source configured to emit blue laser light, and
when a direction in which warmed air rises is upward, the green laser light source and the blue laser light source are disposed above the red laser light source.

### <Appendix 9>

A liquid crystal display device includes:
the surface light source device described in any one of Appendixes 3 to 8; and
a liquid crystal display element that receives the planar light and produces image light.

### DESCRIPTION OF REFERENCE CHARACTERS

100, 110, 120, 130, 140 surface light source device; 200 connection portion; 200a connection line; 11, 12 heat dissipator; 14, 15 holder; 16, 17 heat dissipation portion; 12_{C} warm air; 21, 22, 21_{R}, 21_{G}, 21_{B}, 22_{R}, 22_{G}, 22_{B} laser light source; 25, 25_{R}, 25_{G}, 25_{B}, 25_{W}, 26, 26_{R}, 26_{G}, 26_{B}, 26_{W}, 27 laser beam; 30 casing; 31 opening; 32 bottom plate portion; 33 side plate portion; 34 hole; 40, 50 light guide plate; 400, 500, 450, 550 light guide element; 41, 51, 41_{R}, 41_{GB}, 51_{R}, 51_{GB} incidence surface; 410, 420, 510, 520 tilted surface; 42, 52 emission surface; 453, 553 incidence surface; 43, 53 mixing region; 43a, 47a front surface; 43b, 47b back surface; 44, 54 reflection region; 45, 46, 55, 56 reflection surface; 47, 57 light guide region; 48, 58 region; 49 surface; 60 reflection sheet; 600 reflection portion; light guide plate; 71, 72 incidence surface; 73 emission surface; 80 optical sheet; 90 liquid crystal display element; 900 liquid crystal display device; L separation distance; Ta, Tb, Tc, Td dimension; K angle; C axis.

1. A surface light source device comprising:
laser light sources that emit a plurality of laser beams;
first light guide elements that mix the plurality of laser beams emitted from the laser light sources to convert the plurality of laser beams to linear light; and
a second light guide element that receives the linear light and converts the linear light to planar light,
wherein the laser light sources are disposed in regions surrounded by the first light guide elements so that heat released from the laser light sources to the regions is dissipated.

2. The surface light source device according to claim 1, further comprising heat dissipator that dissipates the heat released to the regions.

3. The surface light source device according to claim 2, wherein the laser light sources are attached to the heat dissipator.

4. The surface light source device according to claim 1, wherein the second light guide element has a plate shape.

5. The surface light source device according to claim 1, wherein each of the first light guide elements has a plate shape.

6. The surface light source device according to claim 1, wherein the regions include a first region and a second region, the first region and the second region being different regions surrounded by the first light guide elements.

7. The surface light source device according to claim 6, wherein:
the laser light sources include a red laser light source configured to emit a red laser beam, a green laser light source configured to emit a green laser beam, and a blue laser light source configured to emit a blue laser beam,
the red laser light source is disposed in the first region, and
the green laser light source and the blue laser light source are disposed in the second region.

8. The surface light source device according to claim 7, wherein, when a direction in which warmed air rises is upward, the second region is disposed above the first region.

9. The surface light source device according to claim 1, wherein each of the first light guide elements includes a light guide region in which the plurality of laser beams are guided and a mixing region in which the plurality of laser beams are mixed.

10. The surface light source device according to claim 9, wherein each of the first light guide elements includes a reflection region that has a reflection surface on which light emitted from the mixing region is reflected, the reflection region emitting light toward the second light guide element.

11. The surface light source device according to claim 10, wherein a part of the light guide region from which light is emitted is connected to a part of the mixing region on which light is incident.

12. The surface light source device according to claim 11, wherein:
the light guide region has a plate shape,
the light guide region has two plane surfaces that are first plane surfaces,
the mixing region has a plate shape,
the mixing region has two plane surfaces that are second plane surfaces and are tilted so that an optical path is widened toward a direction in which the plurality of laser beams travel, and
one of the first plane surfaces is flush with one of the second plane surfaces.

13. The surface light source device according to claim 12, wherein the two first plane surfaces are parallel to each other.

14. The surface light source device according to claim 12, wherein:
when a thickness of the plate shape of a part of the mixing region from which light is emitted is a first dimension, the reflection region has a plate shape and a thickness of the plate shape of the reflection region is a second dimension, and the second light guide element has a plate shape and a dimension of an incidence surface provided at a side surface of the second light guide element is a third dimension, the dimension corresponding to a thickness of the plate shape,
the second dimension is larger than the first dimension and smaller than the third dimension.

15. The surface light source device according to claim 12, wherein:
when a thickness of the plate shape of a part of the mixing region from which light is emitted is a first dimension, the second light guide element has a plate shape and a dimension of an incidence surface provided at a side surface of the second light guide element is a third dimension, the dimension corresponding to a thickness of the plate shape, and another dimension of a light flux emitted from the reflection region is a fourth dimension, the another dimension being in a direction of the third dimension,
the fourth dimension is larger than the first dimension and smaller than the third dimension.

16. A liquid crystal display device comprising:
the surface light source device according to claim 1; and
a liquid crystal display element that receives the planar light to produce image light.

17. The surface light source device according to claim 5, wherein the regions include a first region and a second region, the first region and the second region being different regions surrounded by the first light guide elements.

18. The surface light source device according to claim 9, wherein a part of the light guide region from which light is emitted is connected to a part of the mixing region on which light is incident.

19. The surface light source device according to claim 18, wherein:
the light guide region has a plate shape,
the light guide region has two plane surfaces that are first plane surfaces,
the mixing region has a plate shape,
the mixing region has two plane surfaces that are second plane surfaces and are tilted so that an optical path is widened toward a direction in which the plurality of laser beams travel, and
one of the first plane surfaces is flush with one of the second plane surfaces.

20. The surface light source device according to claim 19, wherein the two first plane surfaces are parallel to each other.
